(19) United States
(12) Patent Application Publication
(10) Pub. No.: US 2025/0115728 A1
(43) Pub. Date: Apr. 10, 2025

(54) METHOD FOR PREPARING POLYURETHANE FOAM USING EXTRACT OF COTTON SPINNING BLACK LIQUOR

(71) Applicant: Tarim University, Alar City (CN)

(72) Inventors: Jianbo Zhao, Alar City (CN); Xiumin Li, Alar City (CN); Cuiping Yang, Alar City (CN); Xuejiao Wang, Alar City (CN); Yuan Zhang, Alar City (CN); Chunhui Shi, Alar City (CN); Lili Huang, Alar City (CN)

(21) Appl. No.: 18/391,702

(22) Filed: Dec. 21, 2023

(30) Foreign Application Priority Data
Oct. 9, 2023 (CN) 2023112967293

(51) Int. Cl. C08J 9/228; C08J 9/00

(52) U.S. Cl. CPC C08J 9/228; C08J 9/0028; C08J 9/0066; C08J 9/0095; C08J 2201/036; C08J 2201/038; C08J 2375/04

(57) ABSTRACT

The present disclosure discloses a method for preparing a polyurethane foam using an extract of cotton spinning black liquor, including the following steps: step (1): extracting biomass in cotton spinning black liquor by acid precipitation to obtain the extract of cotton spinning black liquor; step (2): pretreating the extract of cotton spinning black liquor, and uniformly mixing the pretreated extract of cotton spinning black liquor with a polyether polyol to obtain a mixed raw material; and step (3): preparing the polyurethane foam from the mixed raw material, dibutyltin dilaurate, distilled water, a foam stabilizer, aluminum hypophosphite and an isocyanate by one-step foaming. The present disclosure can solve the problems of high treatment cost and low utilization rate of the existing cotton spinning black liquor.

### TECHNICAL FIELD

The present disclosure relates to the technical field of preparation of polyurethane foams, and particularly to a method for preparing a polyurethane foam using an extract of cotton spinning black liquor.

### BACKGROUND

Polyurethane foam (PUF) is a polymer containing polyurethane segment (-NHCOO-) in its molecular backbone. It is a synthetic material of a high polymer infused with gas prepared by polymerization of isocyanates and polyether polyols or polyester polyols under the action of other additives. Polyurethane foam has wide application prospects in the fields of construction, transportation, daily use and aerospace because of its characteristics of light and porous structure, high specific surface area, network structure, open voids and adjustable density. Because the raw materials of traditional polyurethane foam are all derived from petrochemical products, with the advance of the national strategic goal of “carbon peaking and carbon neutrality”, polyurethane foam will constantly develop in a more efficient, green and environmentally friendly direction, and it will become an irreversible trend to replace polyether polyols with bio-based polyols.

Cotton spinning black liquor is waste liquor mainly produced in the process of preparing cotton pulp from cotton linters by high-temperature alkaline cooking, which has the characteristics of high COD, high chroma and high pH value. It is often used industrially as a raw material for organic fertilizers after being heated and concentrated, which not only causes a waste of energy and resources, but also may bring potential environmental problems. Therefore, in order to use biomass in cotton spinning black liquor more efficiently and reduce the negative impact on the environment, it is necessary to find more advanced treatment means.

### SUMMARY

In view of this, the technical problem to be solved by the present disclosure is to provide a method for preparing a polyurethane foam using an extract of cotton spinning black liquor, to solve the problems of high treatment cost and low utilization rate of the existing cotton spinning black liquor.

In order to solve the above technical problem, the present disclosure provides the following technical solution:

A method for preparing a polyurethane foam using an extract of cotton spinning black liquor includes the following steps:
step (1): extracting biomass in cotton spinning black liquor by acid precipitation to obtain the extract of cotton spinning black liquor;
step (2): pretreating the extract of cotton spinning black liquor, and uniformly mixing the pretreated extract of cotton spinning black liquor with a polyether polyol to obtain a mixed raw material; and
step (3): preparing the polyurethane foam from the mixed raw material, dibutyltin dilaurate, distilled water, a foam stabilizer, aluminum hypophosphite and an isocyanate by one-step foaming.

According to the method for preparing a polyurethane foam using an extract of cotton spinning black liquor, in step (1), a method for extracting the biomass in the cotton spinning black liquor by acid precipitation includes: adding dropwise phosphoric acid into the cotton spinning black liquor with a Baume scale of 3-20° Be′ while stirring to adjust a pH of the cotton spinning black liquor to 4.0-7.0 for precipitation; and after the precipitation is completed, drying the precipitate obtained by centrifugal separation to obtain the extract of cotton spinning black liquor. It is found in the test that when the pH of acid precipitation exceeds 4.0-7.0, for example, when the pH of acid precipitation is 11.0 and when the pH is 1.0, the obtained extract of cotton spinning black liquor can only produce a polyurethane foam with poor quality, and has poor oxypropylation modification and hydroxymethyl modification effects, which is not conducive to the improvement of the quality of the polyurethane foam.

According to the method for preparing a polyurethane foam using an extract of cotton spinning black liquor, in step (1), a method for extracting the biomass in the cotton spinning black liquor by acid precipitation includes: adding dropwise a phosphoric acid solution (the concentration of the phosphoric acid solution may be adjusted according to the viscosity of the cotton spinning black liquor; if the viscosity of the cotton spinning black liquor is high, a phosphoric acid solution with a low concentration is selected; otherwise, phosphoric acid with a high concentration or even solid phosphoric acid may be selected for adjustment) into the cotton spinning black liquor (if it is viscous, it may be diluted with distilled water until it is no longer viscous) with a Baume scale of 5-10° Be′ while stirring to adjust the pH of the cotton spinning black liquor to 4.0 or 7.0 for precipitation (when the acid precipitation is carried out on the cotton spinning black liquor with a Baume scale of 5-10° Be′, the biomass of cotton spinning black liquor can be extracted at a higher yield, and the polyurethane foam prepared using the obtained biomass of cotton spinning black liquor has higher quality); and after the precipitation is completed, carrying out centrifugal separation on the resulting mixture at 5000 rpm for 5 min to obtain a precipitation product, and drying the precipitation product at 60-80° C. for 72-84 h to obtain the extract of cotton spinning black liquor.

According to the method for preparing a polyurethane foam using an extract of cotton spinning black liquor, in step (2), the method for pretreating the extract of cotton spinning black liquor includes: pulverizing the extract of cotton spinning black liquor, passing the pulverized extract of cotton spinning black liquor through a 60-mesh screen, and taking the undersize as the pretreated extract of cotton spinning black liquor.

According to the method for preparing a polyurethane foam using an extract of cotton spinning black liquor, in step (2), the method for pretreating the extract of cotton spinning black liquor includes:
step (2-1): pulverizing the extract of cotton spinning black liquor, and passing the pulverized extract of cotton spinning black liquor through a screen to obtain an extract powder of cotton spinning black liquor;
step (2-2): uniformly mixing the extract powder of cotton spinning black liquor, propylene oxide, anhydrous glycerol, potassium hydroxide and acetone to obtain an oxypropylation modification mixed system; and
step (2-3): carrying out an oxypropylation modification reaction on the oxypropylation modification mixed system in a high-pressure reactor, and after the reaction is completed, cooling the resulting product to room temperature to obtain an oxypropylated modified extract of cotton spinning black liquor, which is the pretreated extract of cotton spinning black liquor.

According to the method for preparing a polyurethane foam using an extract of cotton spinning black liquor, in step (2-1), the extract powder of cotton spinning black liquor is the undersize obtained after the extract of cotton spinning black liquor is pulverized and passed through a 60-mesh screen.

In step (2-2), a mass ratio of the extract powder of cotton spinning black liquor to the propylene oxide to the anhydrous glycerol to the potassium hydroxide to the acetone is 4:4:1.11:0.1:8. The oxypropylation modification according this ratio can make the extract of cotton spinning black liquor have a higher inversion rate of modification groups.

In step (2-3), the oxypropylation modification reaction is carried out at a temperature of 130-170° C. for 2 h.

According to the method for preparing a polyurethane foam using an extract of cotton spinning black liquor, in step (2), the method for pretreating the extract of cotton spinning black liquor includes:
step (2-1): drying and pulverizing the extract of cotton spinning black liquor, and passing the pulverized extract of cotton spinning black liquor through a screen to obtain an extract powder of cotton spinning black liquor;
step (2-2): after uniformly mixing the extract powder of cotton spinning black liquor, formaldehyde and distilled water, refluxing the mixture in a three-necked flask to obtain a hydroxymethyl modification mixed system; and
step (2-3): adjusting a pH of the hydroxymethyl modification mixed system to 2 with hydrochloric acid (under such conditions, the hydroxymethyl modified product can be precipitated as much as possible, thereby increasing the product yield), washing the precipitate to neutral by centrifugation, and finally, drying and pulverizing the precipitate to obtain a hydroxymethyl modified extract of cotton spinning black liquor, which is the pretreated extract of cotton spinning black liquor.

According to the method for preparing a polyurethane foam using an extract of cotton spinning black liquor, in step (2-1), the extract of cotton spinning black liquor is dried at a temperature of 80° C. for 48 h, and the undersize obtained after the extract of cotton spinning black liquor is pulverized and passed through a 60-mesh screen is the extract powder of cotton spinning black liquor.

In step (2-2), a mass ratio of the extract powder of cotton spinning black liquor to the formaldehyde to the distilled water is 5:2:2, and the refluxing is carried out at a temperature of 80° C. for 5 h. Controlling the ratio of the raw materials, and the modification temperature and time to the above conditions can obtain an optimal inversion rate of hydroxyl modification.

In step (2-3), the pH of the hydroxymethyl modification mixed system is adjusted to 2 with the hydrochloric acid with a concentration of 1 mol/L, and the undersize obtained after the precipitate is dried at a temperature of 80° C. for 48 h, pulverized and passed through a 60-mesh screen is the hydroxymethyl modified extract of cotton spinning black liquor.

According to the method for preparing a polyurethane foam using an extract of cotton spinning black liquor, in step (2), a mass fraction of the pretreated extract of cotton spinning black liquor in the mixed raw material is 10-50 wt %.

According to the method for preparing a polyurethane foam using an extract of cotton spinning black liquor, a method for preparing the polyurethane foam by one-step foaming includes:
step (3-1): sequentially adding the dibutyltin dilaurate, the distilled water, the foam stabilizer and the aluminum hypophosphite to the mixed raw material, and uniformly stirring and mixing the mixture to obtain a polyurethane mixed foaming raw material, a mass ratio of the mixed raw material to the dibutyltin dilaurate to the distilled water to the foam stabilizer (dimethicone) to the aluminum hypophosphite being (3-5):(0.03-0.05):(0.15-0.2):(0.15-0.2):(2.25-3.45); where the aluminum hypophosphite added according to this ratio can work together with inorganic salts in the extract of cotton spinning black liquor to play a flame-retardant role, thereby improving the flame retardancy of the polyurethane foam; and
step (3-2): adding the isocyanate to the polyurethane mixed foaming raw material with stirring, and uniformly stirring the mixture; after foaming, transferring the expanded material into a mold, and allowing the expanded material to continue foaming at 50° C. for 1 h; after the foaming is completed, cooling the foam product to room temperature, a mass ratio of the isocyanate to the dibutyltin dilaurate being (3.5-5.75):(0.03-0.05); and
step (3-3): curing the foam product that has been cooled to room temperature at room temperature for 48 h or in an 80° C. oven for 24 h to obtain the polyurethane foam.

The technical solution of the present disclosure has the following beneficial technical effects:
1. According to the present disclosure, the extract of cotton spinning black liquor is extracted from the raw material cotton spinning black liquor by the acid precipitation, and the polyurethane foam is prepared by substituting part of the polyether polyol and isocyanate with the extract of cotton spinning black liquor. The results show that the polyurethane foam prepared from the polyether polyol and the isocyanate with the extract of cotton spinning black liquor has lower apparent density, higher thermal stability, and better flame retardancy and degradability.
2. According to the present disclosure, by controlling the pH of acid precipitation, the extract of cotton spinning black liquor with specific components is obtained. After the extract of cotton spinning black liquor is subjected to oxypropylation modification or hydroxymethyl modification, and the polyurethane foam is prepared by substituting part of the polyether polyol and isocyanate with the oxypropylated modified or hydroxymethyl modified extract while controlling the foaming conditions, so that the finally obtained polyurethane foam has higher thermal stability, flame retardancy and degradability and can be used in a high-temperature environment.

### BRIEF DESCRIPTION OF THE DRAWINGS

FIG. 1A shows functional groups contents in an extract of cotton spinning black liquor in an example of the present disclosure;

FIG. 1B is an infrared spectrum of the extract of cotton spinning black liquor in an example of the present disclosure;

FIG. 2 is a diagram showing apparent densities of polyurethane foams with different substitution rates of the extract of cotton spinning black liquor in an example of the present disclosure;

FIG. 3 shows infrared spectra of the polyurethane foams prepared using the extract of cotton spinning black liquor in an example of the present disclosure;

FIG. 4A, FIG. 4B, FIG. 4C and FIG. 4D are respectively images showing surface morphologies of 0M-PUF, 10M-PUF, 30M-PUF and 50M-PUF polyurethane foams in an example of the present disclosure;

FIG. 5A is a TGA diagram of the polyurethane foams with different substitution rates of the extract of cotton spinning black liquor in an example of the present disclosure;

FIG. 5B is a DTG diagram of the polyurethane foams with different substitution rates of the extract of cotton spinning black liquor in an example of the present disclosure;

FIG. 6 shows thermal conductivities of the polyurethane foams with different substitution rates of the extract of cotton spinning black liquor in an example of the present disclosure;

FIG. 7A, FIG. 7B, FIG. 7C and FIG. 7D are respectively SEM images of residual carbon of the 0M-PUF, 10M-PUF, 30M-PUF and 50M-PUF polyurethane foams in an example of the present disclosure;

FIG. 8A and FIG. 8B are respectively pictures of fire behaviors, and a carbonization length diagram of the polyurethane foams with different substitution rates of the extract of cotton spinning black liquor in a horizontal burning test in an example of the present disclosure;

FIG. 9A, FIG. 9B, FIG. 9C and FIG. 9D are respectively real pictures of the polyurethane foams with different substitution rates of the extract of cotton spinning black liquor after 0 h, 4 h, 8 h and 12 h of degradation in an example of the present disclosure;

FIG. 10 shows degradation rate-time curves of the polyurethane foams with different substitution rates of the extract of cotton spinning black liquor in an example;

FIG. 11 is a flowchart of preparation of the polyurethane foam using an oxypropylated modified extract of cotton spinning black liquor in an example;

FIG. 12 is a phenolic hydroxyl inversion rate-time curve of the extract of cotton spinning black liquor during oxypropylation modification in an example;

FIG. 13A and FIG. 13B respectively show infrared spectra of the extract of cotton spinning black liquor and the oxypropylated modified extract and infrared spectra of the polyurethane foams prepared therefrom in an example of the present disclosure;

FIG. 14A, FIG. 14B, FIG. 14C and FIG. 14D are respectively images showing surface morphologies of PU0, MPUB10, MPUB30 and MPUB50 polyurethane foams in an example of the present disclosure;

FIG. 15 is a diagram showing apparent densities of polyurethane foams with different substitution rates of the oxypropylated modified extract of cotton spinning black liquor in an example;

FIG. 16 is a diagram showing thermal conductivities of the polyurethane foams with different substitution rates of the oxypropylated modified extract of cotton spinning black liquor in an example;

FIG. 17A and FIG. 17B are TG and DTG curve diagrams of the polyurethane foams with different substitution rates of the oxypropylated modified extract of cotton spinning black liquor in an example;

FIG. 18A, FIG. 18B, FIG. 18C and FIG. 18D are respectively images showing microscopic morphologies of residual carbon of the PU0, MPUB10, MPUB30 and MPUB50 polyurethane foams in an example of the present disclosure;

FIG. 19A and FIG. 19B are respectively pictures, and a carbonization length diagram of the polyurethane foams with different substitution rates of the oxypropylated modified extract of cotton spinning black liquor in a horizontal burning test in an example of the present disclosure;

FIG. 20A shows pictures of degradation of the polyurethane foams with different substitution rates of the oxypropylated modified extract of cotton spinning black liquor with time in an example of the present disclosure;

FIG. 20B is a degradation rate curve diagram of the polyurethane foams with different substitution rates of the oxypropylated modified extract of cotton spinning black liquor in an example of the present disclosure;

FIG. 21 is a diagram showing a hydroxymethylation reaction of the extract of cotton spinning black liquor in an example of the present disclosure;

FIG. 22 is a diagram showing functional groups of the extract of cotton spinning black liquor and the hydroxymethyl modified extract in an example of the present disclosure;

FIG. 23A and FIG. 23B respectively show infrared spectra of the extract of cotton spinning black liquor and the hydroxymethyl modified extract and infrared spectra of the polyurethane foams prepared therefrom in an example of the present disclosure;

FIG. 24A, FIG. 24B, FIG. 24C and FIG. 24D are respectively images showing surface morphologies of PUF0, MPUF10, MPUF30 and MPUF50 polyurethane foams in an example of the present disclosure;

FIG. 25 is a diagram showing apparent densities of the polyurethane foams with different substitution rates of the hydroxymethyl modified extract of cotton spinning black liquor in an example of the present disclosure;

FIG. 26A, FIG. 26B, FIG. 26C and FIG. 26D are respectively SEM images of the PUF0, MPUF10, MPUF30 and MPUF50 polyurethane foams in an example of the present disclosure;

FIG. 27A and FIG. 27B are TG and DTG curve diagrams of the polyurethane foams with different substitution rates of the hydroxymethyl modified extract of cotton spinning black liquor in an example;

FIG. 28 is a diagram showing thermal conductivities of the polyurethane foams with different substitution rates of the hydroxymethyl modified extract of cotton spinning black liquor in an example;

FIG. 29A and FIG. 29B are respectively pictures, and a carbonization length diagram of the polyurethane foams with different substitution rates of the hydroxymethyl modified extract of cotton spinning black liquor in a horizontal burning test in an example of the present disclosure;

FIG. 30A shows pictures of degradation of the polyurethane foams with different substitution rates of the hydroxymethyl modified extract of cotton spinning black liquor with time in an example of the present disclosure; and

FIG. 30B is a degradation rate curve diagram of the polyurethane foams with different substitution rates of the hydroxymethyl modified extract of cotton spinning black liquor in an example of the present disclosure.

### DETAILED DESCRIPTION

### Part One: Preparation of Polyurethane Foam Using Extract of Cotton Spinning Black Liquor

### 1. Materials and Methods

### 1.1 Experimental Raw Materials, Reagents and Experimental Instruments

Cotton spinning black liquor, provided by Xinjiang Alar City Zhongtai Textile Technology Co., Ltd.; dibutyltin dilaurate (DBT, analytically pure), dimethicone as a foam stabilizer (FS, analytically pure), polyether polyol PEG-4110 (polyether polyol with a molecular weight of 4110 or so, a content of >99% and a hydroxyl value of 430-470 mgKOH/g), isocyanate (PMDI, PM200), purchased from Shanghai Macklin Biochemical Co., Ltd.; aluminum hypophosphite (analytically pure), sodium hydroxide (analytically pure) and methanol (analytically pure), purchased from Sinopharm Chemical Reagent Co., Ltd. All the reagents were not treated before use.

SHJ-6A magnetic stirring thermostatic water bath; DF-101S heat-gathering magnetic stirrer; PHS3-3C pH meter; BSA224S electronic balance; centrifuge; high speed pulverizer; Nicolet iS10 Fourier infrared spectrometer FTIR; SU8020 scanning electron microscope (SEM); AA-7000 optical microscope; TPS2500S thermal constant analyzer; TA449F3 thermogravimetric analyzer; YG086D flame retardancy tester.

### 1.2 Experimental Method

### 1.2.1 Extraction of Biomass in Cotton Spinning Black Liquor

The biomass in the cotton spinning black liquor was extracted by acid precipitation. A right amount of cotton spinning black liquor with a Baume scale of 5-10° Be′ was added to a 250 ml beaker ((if the cotton spinning black liquor raw material was viscous, it may be diluted with distilled water until it was no longer viscous), and magnetically stirred. Phosphoric acid was added dropwise to adjust a pH of the solution to 4.0 (under such acid precipitation conditions, the cotton spinning black liquor biomass had the highest yield, the extracted cotton spinning black liquor biomass had the best quality, and the foaming system for preparing the polyurethane foam in which the polyether polyol was substituted with the cotton spinning black liquor biomass had a good foaming effect). The mixture was centrifuged in a centrifuge (at 5000 r/min for 5 min). The precipitate was put into an oven and dried at 80° C. for 72 h. The dried extract of cotton spinning black liquor was pulverized in the high speed pulverizer, and passed through a 60-mesh screen. The undersize was sealed and preserved for later use.

### 1.2.2 Preparation of Polyurethane Foams Based on Cotton Spinning Black Liquor

Certain amounts of extract of cotton spinning black liquor and polyether polyol respectively weighed according to Table 1, 0.05 g of dibutyltin dilaurate, 0.2 g of distilled water, 0.2 g of foam stabilizer and 3.45 g of aluminum hypophosphite were put into a paper cup, and stirred for 15 s to obtain a component A for later use. 5.75 g of isocyanate PMDI was weighed as a component B. The component B was added to the component A with stirring, and then stirred at high speed for 20 s to prepare a series of polyurethane foams by one-step foaming (at 50° C. for 1 h). After the foaming was completed, the resulting product was cooled to room temperature, demolded, and cured in an 80° C. oven for 24 h.

TABLE 1
Raw materials of polyurethane foams with different
substitution rates of cotton spinning black liquor

| | | Extract of cotton | |
|---|---|---|---|
| | | spinning black | Substitution rate |
| No. | Polyether polyol (g) | liquor (g) | (%) |
| 0M-PUF | 5 | 0 | 0 wt % |
| 10M-PUF | 4.5 | 0.5 | 10 wt % |
| 20M-PUF | 4 | 1 | 20 wt % |
| 30M-PUF | 3.5 | 1.5 | 30 wt % |
| 40M-PUF | 3 | 2 | 40 wt % |
| 50M-PUF | 2.5 | 2.5 | 50 wt % |

### 1.3 Sample Characterization

### 1.3.1 Determination of Functional Group Content

Contents of carboxyl, phenolic hydroxyl and alcoholic hydroxyl in the extract of cotton spinning black liquor were tested by titration. Determination of total acidic groups: 0.1 g of sample was respectively added to 25 mL of Ba(OH)₂ standard solution with a concentration of 0.2 mol/L and distilled water to obtain test solutions 1 and 2. A ball condenser was mounted, and placed in a boiling water bath. After 2 h of refluxing, the ball condenser was removed. The test solution 1 was suction-filtered through a Buchner funnel into a suction flask filled with 30 mL of 0.1 mol/L HCl standard solution. The test solution 2 was filtered into another suction flask. The precipitates were respectively washed with distilled water until the pH was 7. The filtrate 1 and the filtrate 2 were respectively transferred into a 250 mL beaker, and subjected to potentiometric titration with a 0.1 mol/L NaOH standard solution until the pH of the solution reached 8.5. A blank experiment was carried out without adding samples under the same conditions according to the same steps of the test solution 1. The total acidic group content may be obtained according to formula (1). The determination was carried out in 3 replicates.

$$[ AcidicGroup ] ( m mol / g ) = \frac{C ( {V}_{1} - {V}_{2} - {V}_{3} )}{m} \qquad ( 1 )$$

where C is the concentration of the NaOH standard solution in mol/L; V₁, V₂ and V₃ are respectively volumes of the NaOH standard solution consumed by the test solutions 1 and 2 and the blank experiment in mL; and m is the mass of the sample in g.

Determination of carboxyl content: 0.1 g of sample was respectively added to 50 mL of 0.5 mol/L Ca(Ac)₂ standard solution and distilled water to obtain test solutions 1 and 2. A ball condenser was mounted, and placed in a boiling water bath. After 2 h of refluxing, the ball condenser was removed. Filtration was carried out, and the precipitates were respectively washed with distilled water until the pH was 7. The obtained filtrates were subjected to potentiometric titration with a 0.1 mol/L NaOH standard solution until the pH of the solution reached 8.5. A blank experiment was carried out without adding samples under the same conditions according to the same steps of the test solution 1. The carboxyl content may be obtained according to formula (2). The determination was carried out in 3 replicates.

$$[ COOH ] ( m mol / g ) = \frac{C ( {V}_{1} - {V}_{2} - {V}_{3} )}{m} \qquad ( 2 )$$

where C is the concentration of the NaOH standard solution in mol/L; V₁, V₂ and V₃ are respectively volumes of the NaOH standard solution consumed by the test solutions 1 and 2 and the blank experiment in mL; and m is the mass of the sample in g.

Determination of aromatic hydroxyl content: The aromatic hydroxyl content may be obtained according to the difference between the total acidic group content and the carboxyl content, as shown in formula (3).

$$[ A - OH ] ( m mol / g ) = [ AcidicGroup ] - [ COOH ] \qquad ( 3 )$$

where [AcidicGroup] is the concentration of the total acidic group in mmol/L, and [COOH] is the concentration of the carboxyl in mmol/L.

Determination of aliphatic hydroxyl content: 1 g of extract powder of cotton spinning black liquor was weighed and added to a dried iodine number flask. 5 mL of phthalic anhydride was added, and the iodine number flask was put into a thermostatic water bath and kept in the thermostatic water bath at 65° C. for 30 min. The iodine number flask was taken out and cooled to room temperature. 10 mL of pyridine was added, and 5 drops of phenolphthalein was added. The mixture was titrated with a 0.5 mol/L NaOH standard solution until the solution became pink and retained no fading within 30 s. A blank experiment was carried out without adding samples under the same conditions. The alcoholic hydroxyl content may be obtained according to formula (4). The determination was carried out in 3 replicates.

$$[ R - OH ] ( m mol / g ) = \frac{c ( {V}_{1} - {V}_{2} )}{m} \qquad ( 4 )$$

where C is the concentration of the NaOH standard solution in mol/L; V₁ and V₂ are respectively volumes of the NaOH standard solution consumed by the test sample and the blank experiment in mL; and m is the mass of the sample in g.

### 1.3.2 Other Tests

Apparent density test: The apparent density of the polyurethane foam was tested with reference to GB/T6343-2009. The foam was cut into a regular cube, and the mass of the regular cube was measured (accurate to 0.001 g). The length, width and height were measured with a vernier caliper, and the volume and density were calculated. The determination was carried out in 5 replicates.

Infrared spectrum (FT-IR) analysis: The test was carried out by a KBr pellet method. A small amount of sample to be tested was put into an agate mortar, and 200-300 mg of spectroscopically pure potassium bromide was mixed and ground with the sample. The mixture was dried in an infrared oven and pelletized. The pellets were put into the instrument and tested. The number of scans was 40, and the scan range was 4000-400 cm⁻¹.

Optical microscope analysis: The surface structure of the polyurethane foam was observed using the AA-7000 optical microscope. The sample was cut into a thin slice with a proper size. The sample was placed on a glass slide. The aperture was adjusted, and the eyepiece was moved. The sample was observed under a magnification of 40 times. Thermogravimetric analysis (TGA): The thermal properties of the polyurethane foam sample was tested using a TA449F3 thermogravimetric analyzer under the protection of N₂. The gas flow rate was 20 mL/min, the heating speed was 10.0 K/min, and the range was 40-700° C.

Thermal conductivity analysis: The thermal conductivity of the polyurethane foam was determined using the TPS2500S thermal constant analyzer, and the sample size was 30 mm×30 mm×10 mm.

Scanning electron microscope (SEM) analysis: The polyurethane foam sample was cut into a thin slice, which was completely combusted. The sample was placed on a sample stage, and a conductive tape was wound around the corners to prevent the sample from moving. After a thin metal coating was deposited on the residual carbon, the surface of the residual carbon after the polyurethane foam was combusted was observed using the SU8020 scanning electron microscope.

### 1.4 Performance Testing

### 1.4.1 Horizontal Burning Test

The horizontal burning test was carried out using the YG086D flame retardancy tester, and the test sample was cut into a 100 mm×15 mm×15 mm bar. The sample bar was placed on a sample holder, and pushed slowly along the guide rail to the top end of the guide rail. At the same time, a timing device was used to control an igniter to ignite the sample bar. The flame spread time and distance were recorded and measured.

### 1.4.2 Degradability Test

A 0.5 mol/L sodium hydroxide solution was prepared, and mixed with methanol according to a volume ratio of 1:1 to prepare a methanol-0.5 mol/L sodium hydroxide aqueous solution. The prepared polyurethane foam was cut into a 0.5 cm×0.5 cm×1 cm small cuboid. The small cuboid was weighed, and its mass was recorded as M₁. Then, the small cuboid was placed in a sample flask filled with the methanol-0.5 mol/L sodium hydroxide aqueous solution. The sample flask was placed in a 60° C. water bath. The degradation of the foam was observed at 0, 4, 8 and 12 h respectively. The residue after degradation was dried in a 50° C. vacuum drying oven for 8 h, and then weighed, and its mass was recorded as M₂. The degradation rate of the polyurethane foam was calculated according to formula (5).

$$R = \frac{{M}_{1} - {M}_{2}}{{M}_{1}} \times 100 \% \qquad ( 5 )$$

where R is the degradation rate in %; M₁ is the initial mass of the foam in g; and M₂ is the mass of the foam residue after degradation in g.

### 2. Results and Analysis

### 2.1 Analysis Functional Groups of Extract of Cotton Spinning Black Liquor

The contents of carboxyl, aromatic hydroxyl and aliphatic hydroxyl of the extract of cotton spinning black liquor were tested by titration, and the functional groups of the extract of cotton spinning black liquor were characterized by FT-IR.

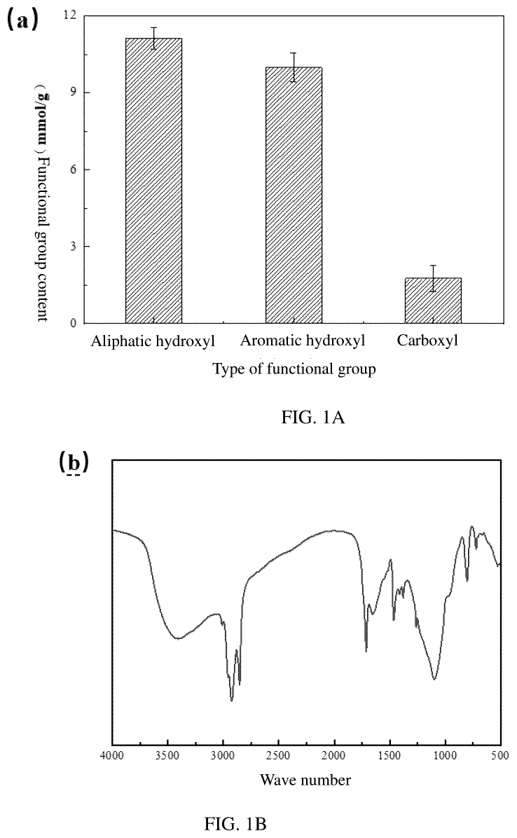

Generally, the carboxyl in organic acids has a pKa of about 4.2, so the pH of acid precipitation was 4 in this example. As can be seen from FIG. 1A, in the extract of cotton spinning black liquor, the carboxyl content was low, so the content of organic acids was low in the extract; and moreover, the hydroxyl content was high, and the alcoholic hydroxyl content was 11.113 mmol/g, which was converted into a hydroxyl value of 622 mgKOH/g, which was higher than that of the raw material polyether polyol PEG-4110, indicating that it was feasible to use the extract of cotton spinning black liquor to partially substitute the polyether polyol in the preparation of polyurethane foams based on the cotton spinning black liquor. As can be seen from FIG. 1B, the significant characteristic peak of the extract of cotton spinning black liquor appeared at 3433 cm⁻¹, which was due to the stretching vibration of hydroxyl, the peaks at 2961-2850 cm⁻¹ were characteristic peaks of methyl and methylene, the characteristic peaks at 1712, 1650 and 1466 cm⁻¹ were due to stretching vibrations of the carbon-carbon bond of the aromatic ring skeleton, and the characteristic peak at 1375 cm⁻¹ was due to the ether bond, which also proved that the extract of cotton spinning black liquor was rich in carboxyl.

### 2.2 Apparent Density of Polyurethane Foam

Apparent densities of polyurethane foams with different substitution rates of the extract of cotton spinning black liquor were tested according to GB/T6343-2009. The results are shown in the figure below.

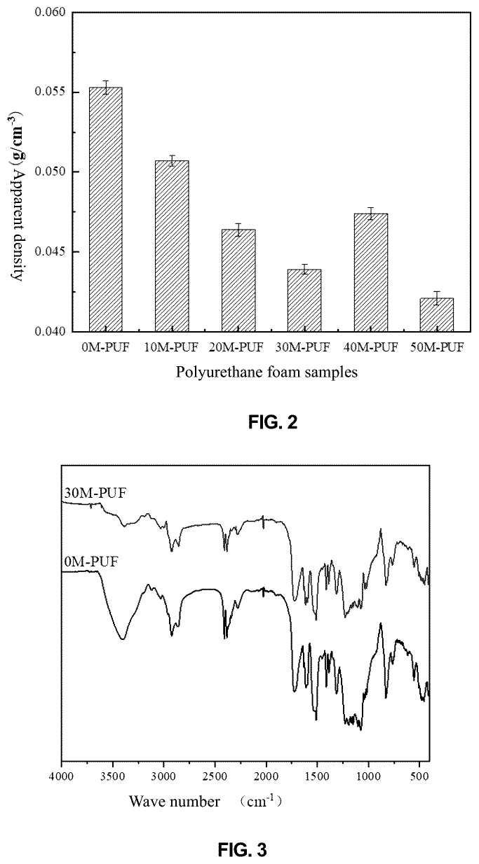

As can be seen from FIG. 2, 0M-PUF had an apparent density of 0.0553 g/cm³, and the 50M-PUF had the lowest apparent density of 0.0421 g/cm³, both of which met the national standard (0.04-0.06 g/cm³). The addition of the extract of cotton spinning black liquor reduced the apparent density of the polyurethane foam. This may be because poor structural uniformity of the lignin structure in the extract of cotton spinning black liquor may lead to large cells in the foaming process, causing a reduction in the density of the material. A lower apparent density could make the polyurethane foam more advantageous in certain fields such as construction, transportation and aerospace.

### 2.3 FT-IR Analysis of Polyurethane Foam

The polyurethane foams prepared by partially substituting polyether polyol with the extract of cotton spinning black liquor were subjected to infrared spectrum analysis. FIG. 3 shows infrared spectra of 0M-PUF and 30M-PUF. As can be seen, the trends of the two curves were basically the same. The absorption peaks at 3400 cm⁻¹ were due to the stretching vibration of —OH and the stretching vibration of N—H, the absorption peaks at 2975-2848 cm⁻¹ were due to the stretching vibrations of C—H, the absorption peaks at 1722 cm⁻¹ were due to the characteristic vibrations of the C═O group, and the peaks at 1513 cm⁻¹ and 1065 cm⁻¹ belonged to the extensional vibrations of C—N coupling and C—O. All the above characteristic peaks indicated the presence of the carbamate bond structure, which indicated that the extract of cotton spinning black liquor chemically reacted with the isocyanate and did not react with other components.

### 2.4 Surface Morphology of Polyurethane Foam

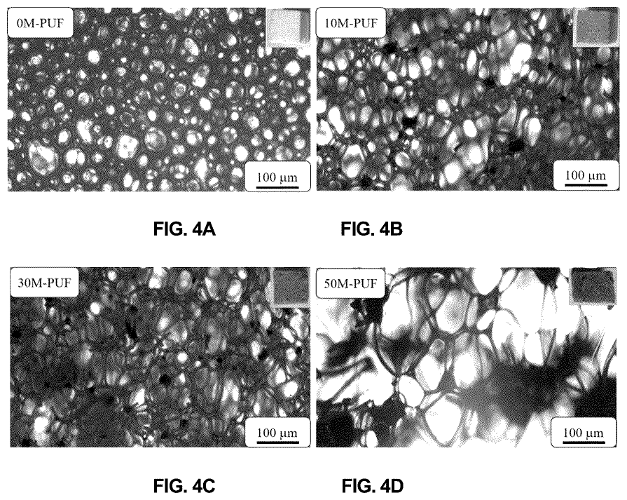

The polyurethane foams with different substitution rates of the extract of cotton spinning black liquor were respectively cut into small slices with a thickness of 1-2 mm, and each small slice was placed on the optical microscope to observe its surface morphology. As can be seen from FIG. 4A to FIG. 4D, the color of the samples became darker and darker as the substitution rate of the extract of cotton spinning black liquor increased. As can be seen from the photos of the optical microscope, the 0M-PUF sample had a uniform and orderly cell size, and with the increase of the extract of cotton spinning black liquor, the surface structure of the polyurethane foams became fragmented, and the greater the substitution rate, the more its original dense structure was destroyed. This was because the chemical structure of the extract of cotton spinning black liquor was not as clear as that of the polyether polyol, and the extract of cotton spinning black liquor contained impurities that could not react with the isocyanate such that the structural regularity was destroyed.

### 2.5 Thermogravimetric Analysis of Polyurethane Foam

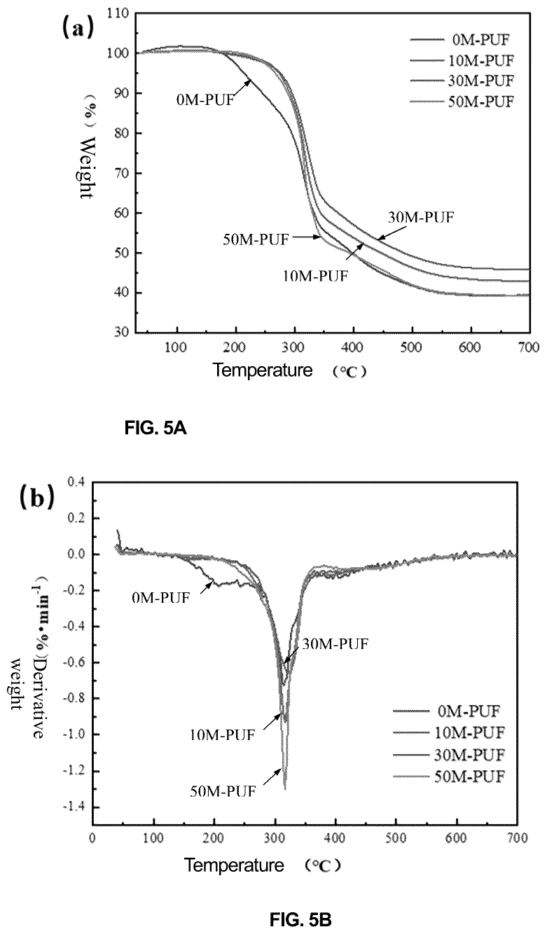

The polyurethane foams with different substitution rates of the extract of cotton spinning black liquor were subjected to thermogravimetric analysis. As can be seen from FIG. 5A and FIG. 5B, the initial thermal decomposition temperature of the 0M-PUF foam was 177° C., and only one thermal degradation peak appeared at 322° C., which was mainly the breakage of the urethane main chain. With the addition of the extract of cotton spinning black liquor, the initial decomposition temperature of the polyurethane foam was very significantly delayed, and the initial decomposition temperature of the 30M-PUF foam was delayed by 37° C. to 214° C. At the end point 700° C., the weight loss rate of the 30M-PUF foam was 55%, and the weight loss rate of the 0M-PUF foam was 62%. The possible reason was that the extract of cotton spinning black liquor was difficult to burn due to its high carbon content, and the formed carbon layer hindered the further degradation of the polymer; and with the increase of the substitution rate of the extract of cotton spinning black liquor, more irregular cells appeared on the surface, which contributed to the flow of heat stream and the increase of the weight loss rate. This indicated that the addition of the extract of cotton spinning black liquor could improve the heat resistance and thermal stability of the polyurethane foam.

### 2.6 Thermal Conductivity of Polyurethane Foam

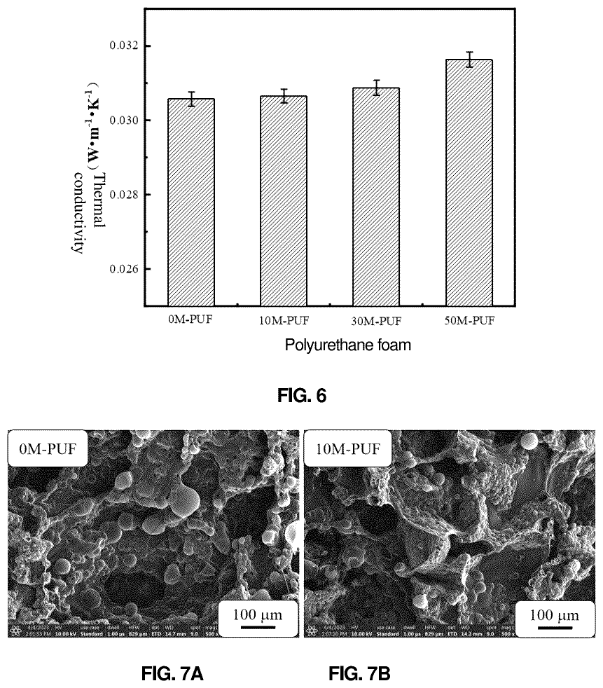

The thermal conductivity coefficients of the polyurethane foams with different substitution rates of the extract of cotton spinning black liquor were tested. The thermal conductivity of the polyurethane foam reflects the thermal insulation performance of the material. A low thermal conductivity of the material indicates a low thermal conduction performance, but an outstanding thermal insulation effect of the material. As can be seen from FIG. 6, the thermal conductivity of 0M-PUF was 0.03058 W·m⁻¹·K⁻¹. After the extract of cotton spinning black liquor was added, the thermal conductivity of the foam increased slightly. The thermal conductivity of 50M-PUF was 0.03164 W·m⁻¹·K⁻¹. This was mainly because a high substitute rate of the extract of cotton spinning black liquor may lead to the damage of cell walls of the polyurethane foam, so that the heat was lost easily, causing an increase of the thermal conductivity.

### 2.7 SEM Analysis of Residual Carbon of Polyurethane Foam

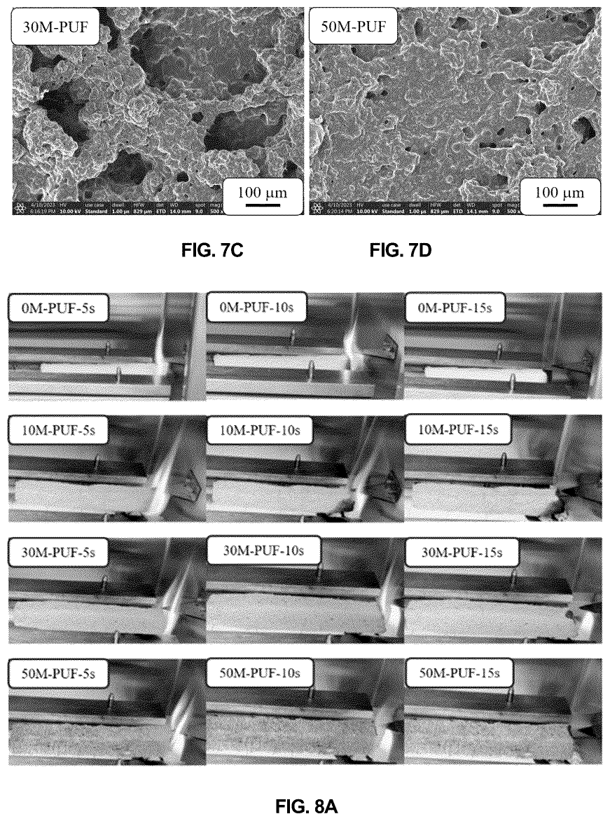

A thin metal coating was deposited on the residual carbon after complete combustion of the polyurethane foam, and the surface morphology was photographed by the scanning electron microscope (SEM). As can be seen from FIG. 7A to FIG. 7D, the surface of 0M-PUF was covered with large cells, but the surface of the carbon layer after the polyurethane foam with the extract of cotton spinning black liquor was combusted had much fewer cells and cracks, and the density of the carbon layer became more uniform and smooth. This was because when the polyurethane foam was combusted, a carbon layer was formed on the surface of the material, and the extract of cotton spinning black liquor reinforced the carbon layer to some extent. This carbon layer covering the surface of the substrate had the effects of heat insulation and oxygen isolation, thus preventing flame from spreading to the inside of the material.

### 2.8 Horizontal Burning of Polyurethane Foam

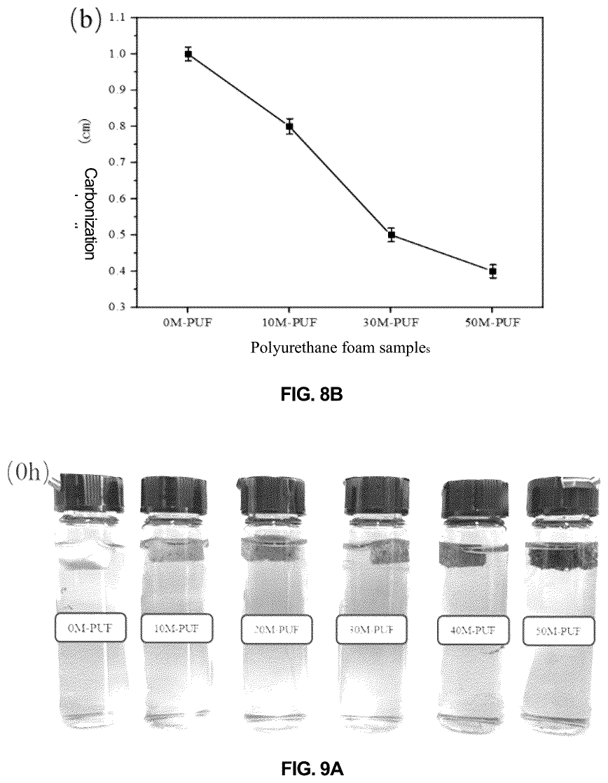

The horizontal flammabilities of the polyurethane foams with different substitution rates of the extract of cotton spinning black liquor were tested. As can be seen from FIG. 8A, all the polyurethane foams had excellent flame retardancy, and the flame gradually decreased and went out with time; the 0M-PUF foam material did not burn as well as the foam material with the extract of cotton spinning black liquor after 15; and the flame of the 50M-PUF foam went out faster and the carbonization length formed after combustion was the shortest (FIG. 8B), which was only 0.4 cm. This was because after the polyurethane foam was combusted, a carbon layer was formed, and the extract of cotton spinning black liquor may reinforce this carbon layer, which could isolate oxygen and absorb heat. As a result, the addition of the extract of cotton spinning black liquor could improve the flame retardancy of the polyurethane foam.

### 2.9 Degradation of Polyurethane Foam

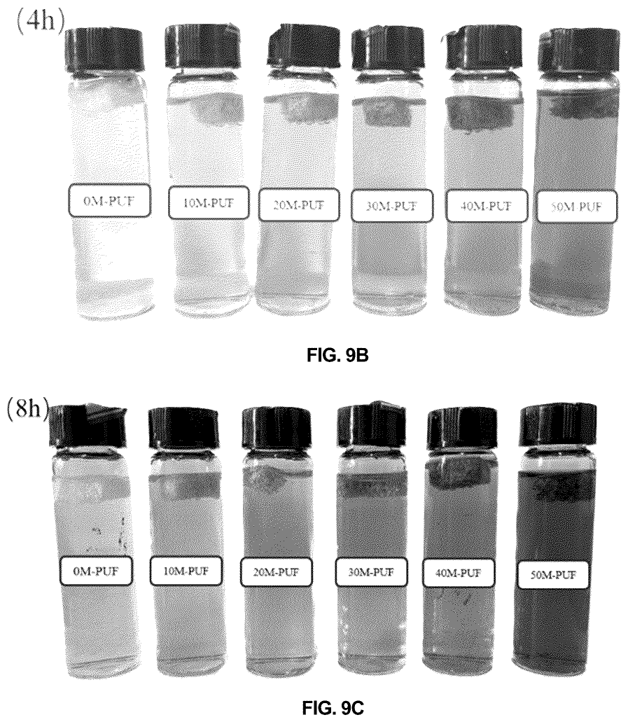

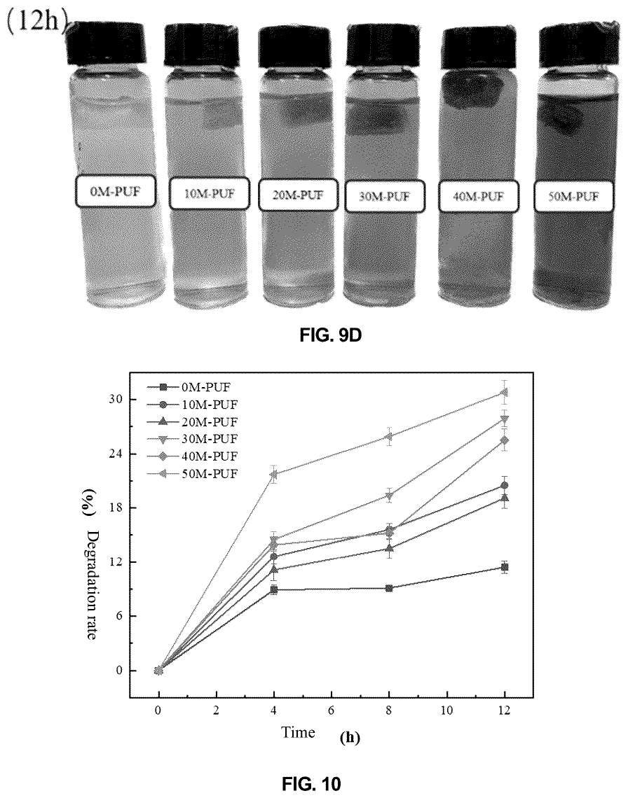

The polyurethane foams with different substitution rates of the extract of cotton spinning black liquor were cut and put into the methanol-0.5 mol/L sodium hydroxide aqueous solution, and the degradabilities of the materials were tested. As can be seen from FIG. 9A to FIG. 9D, the polyurethane foam could be degraded in the methanol-0.5 mol/L NaOH solution, and with the addition of the extract of cotton spinning black liquor, the degradation rate became higher. As can be seen from FIG. 10, when the substitution rate of the extract of cotton spinning black liquor reached 30% or above, the degradation rate increased quickly, and the degradation rate of 50M-PUF at 12 h reached 30.8%. This was mainly because the addition of the extract of cotton spinning black liquor destroyed the regular structure of the polyurethane foam such that the solvent could permeate easily, thereby accelerating the degradation of the polymer. In addition, the extract of cotton spinning black liquor itself belongs to biomass resources and has good degradability.

Based on the above, in this example, the cotton spinning black liquor was used as the raw material, the hydroxyl content in the extract of cotton spinning black liquor obtained by acid precipitation was determined by titration, the polyurethane foams were prepared by partially substituting the polyether polyol with the extract of cotton spinning black liquor, and the polyurethane foams with different substitution rates of the extract of cotton spinning black liquor were characterized by the FT-IR, optical microscope, TGA and SEM. The results showed that the alcoholic hydroxyl content in the extract of cotton spinning black liquor was 11.113 mmol/g, which indicated that it was feasible to use the extract of cotton spinning black liquor to partially substitute the polyether polyol in the preparation of the polyurethane foam; and when the substitution rate of the extract of cotton spinning black liquor was 30%, the apparent density of the material was 0.0439 g/cm³, the thermal conductivity was 0.03088 W·m⁻¹·K⁻¹, the initial decomposition temperature was 214° C., the residual carbon at 700° C. could reach 45%, the residual carbon layer was denser and smoother under the SEM, and the carbonization length in horizontal burning was 0.5 cm. As a result, the material had excellent heat resistance and flame retardancy. In addition, the material had excellent degradability, and the degradation rate after 12 h was 27.9%.

### Part Two: Preparation of Polyurethane Foam Using Oxypropylated Modified Extract of Cotton Spinning Black Liquor

### 1. Experimental Part

### 1.1 Main Raw Materials

Propylene oxide, anhydrous glycerol, acetone, hydrochloric acid and calcium acetate were all purchased from Sinopharm Chemical Reagent Co., Ltd., and were all analytically pure. The sources and specifications of other raw materials were the same as those in Part One.

### 1.2 Main Equipment and Instruments

TGYF-B-100 high-pressure reactor; YP20002 electronic balance; GZX-9246 MBE digital-display blast drying oven; SHZ-D circulating-water vacuum pump; CU-6 optical microscope; Nicolet iS10 Fourier infrared spectrometer; HITACHI SU8020 scanning electron microscope; TA449F3 thermogravimetric analyzer; TPS2500S thermal constant analyzer; YG(B)810D-II horizontal flammability tester.

### 1.3 Preparation of Samples

### 1.3.1 Oxypropylation Modification of Extract of Cotton Spinning Black Liquor

Propylene oxide (4.0 g), anhydrous glycerol (1.11 g), KOH (0.1 g), acetone (8.0 g) and the extract of cotton spinning black liquor (4.0 g, passed through a 60-mesh screen) were uniformly mixed, held in a miniature magnetic high-pressure reactor at a speed of 400 rpm respectively at temperatures of 130, 140, 150, 160 and 170° C. for 2 h, and allowed to stand to room temperature. Then, the resulting product was taken out of the inner container for later use, thereby obtaining the oxypropylation modification product of the extract of cotton spinning black liquor.

The extract of cotton spinning black liquor was obtained according to the method in “1.2.1 Extraction of biomass in cotton spinning black liquor” in Part One, except that: phosphoric acid was added to adjust the pH of the solution to 7.0 (the extract of cotton spinning black liquor obtained under this acid precipitation condition could obtain better modification effects during the oxypropylation modification than the extract of cotton spinning black liquor obtained by acid precipitation at the pH of 4.0), and the precipitate was subjected to centrifugal separation and then dried at 60° C.

### 1.3.2 Preparation of Polyurethane Foams Based on Extract of Cotton Spinning Black Liquor

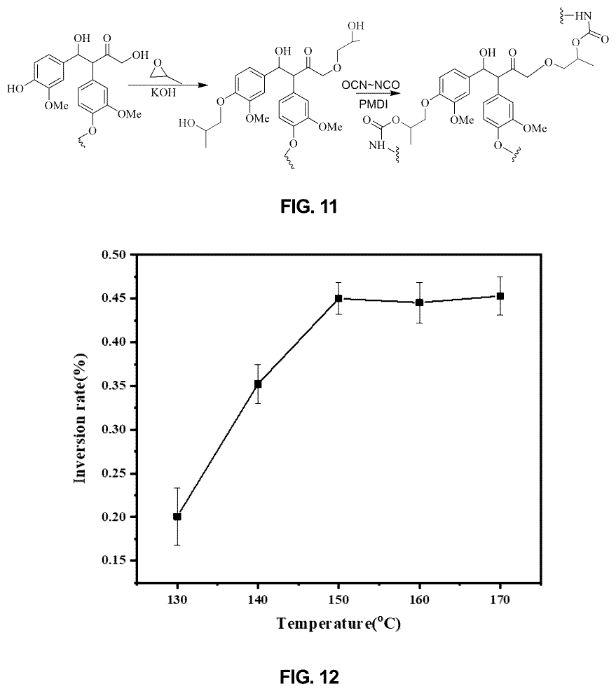

The polyurethane foams were prepared by one-step foaming, as shown in FIG. 11: First, a certain amount of the oxypropylation modification product of the extract of cotton spinning black liquor was weighed and added to the polyether polyol, totaling 3.0 g. The mixture was stirred vigorously at 500 rpm for 5 min to obtain a uniform mixture. Dibutyltin dilaurate (0.03 g), distilled water (0.15 g), a foam stabilizer (0.15 g) and aluminum hypophosphite (2.25 g) were sequentially added to the mixture, and the resulting mixture was stirred at 1000 rpm for 30 s, so that all the components were uniformly mixed to minimize the evaporation of the foaming agent. Then, isocyanate PMDI (3.5 g) was added to the mixture, and stirred at 2000 rpm for 30 s such that a free-rising foam was produced in an open plastic cup. Finally, the reaction was carried out in a 50° C. convection oven for 1 h, and the resulting product was taken out and cured at room temperature for 48 h to obtain the polyurethane foam based on the extract of cotton spinning black liquor. In this example, the polyurethane foams with 0 wt %, 10 wt %, 20 wt %, 30 wt %, 40 wt % and 50 wt % of the oxypropylation modification product of the extract of cotton spinning black liquor were respectively named PU0, MPUB10, MPUB20, MPUB30, MPUB40 and MPUB50.

### 1.4 Performance Testing and Structural Characterization

Determination of phenolic hydroxyls: Oxypropylation modification is to convert phenolic hydroxyls into alcoholic hydroxyls. The phenolic hydroxyl contents before and after the reaction of the sample may be tested to calculate the percentage of phenolic hydroxyls converted into alcoholic hydroxyls. The content of phenolic hydroxyls in the extract of cotton spinning black liquor was tested by titration. The methods of determining the contents of total acidic groups, carboxyls and aromatic hydroxyls were the same as the corresponding methods in Part One.

Infrared spectrum (FTIR) analysis: The Nicolet iS10 infrared spectrometer was used. 0.5 mg of extracts of cotton spinning black liquor and polyurethane foams before and after modification were respectively uniformly ground with 50 mg of KBr, pelletized, and scanned in the instrument at room temperature. The scan range was 4000-400 cm⁻¹, and the number of scans was 32.

Optical microscope analysis: The surface morphology of the sample was observed by the CU-6 optical microscope. The polyurethane foam sample was cut into a thin slice with a proper size, and the magnification was 40 times.

SEM analysis: The morphology of the residual carbon after the sample was combusted was observed using the SU8020 scanning electron microscope. A carbon residue test specimen was cut with a blade. A thin metal coating was deposited on the residual carbon test specimen at an accelerated voltage of 5 kV.

Apparent density test: The apparent density of the polyurethane foam was tested according to the method in GB/T6343-2009 “Cellular Plastics and Rubbers-Determination of Apparent (Bulk) Density”. The foam was cut into a regular cuboid, and the cuboid was weighed (accurate to 0.001 g). The length, width and height of the cuboid were measured with a vernier caliper, and the volume and density of the cuboid were calculated.

TG analysis: The thermal properties of the material were characterized using the TA449F3 thermogravimetric analyzer in an N₂ atmosphere. The heating rate was 10° C./min, the heating range was 40° C. to 700° C., and the flow rate was 10 mL/min.

Thermal conductivity analysis: The thermal conductivity was characterized using the HotDisk TPS2500S thermal conductivity analyzer according to a transient plane heat source method.

Horizontal burning test: The testing was carried out according to the standard GB/T8332-2008 “Test Method for Flammability of Cellular Plastic-Horizontal Burning Method”. The sample size was 1.5 cm×1.5 cm×10 cm. A butane torch and a combustion tester were used. The sample was combusted at the flame for 15 s, and then the butane torch was turned off. The length of the sample after combustion was measured.

Degradability testing: A mixed solution of a methanol (CH₃OH) solution and a 0.5 mol/L NaOH solution in a volume ratio of 1:1 and a 1×1×1 cm³ cube of the polyurethane foam based on the extract of cotton spinning black liquor, whose original mass had been recorded, were put into a sample flask and placed in a 60° C. water bath. The degradation of the foam was observed, and the residue after degradation was collected and dried in a 40° C. vacuum drying oven for 12. The mass of the residue was measured. The degradability of the foam was analyzed by calculating the degradation rate of the foam. The degradation rate was calculated according to following formula.

$$η = \frac{{M}_{b}}{{M}_{a}} \times 100 \%$$

where η is the degradation rate in %, Mₐ is the original mass of the foam in g, and M_{b} is the mass of the residue after degradation in g.

### 2. Results and Discussion

### 2.1 Inversion Rate of Phenolic Hydroxyl in Extract of Cotton Spinning Black Liquor

As shown in FIG. 12, the inversion rate of phenolic hydroxyl in the extract of cotton spinning black liquor increased as with the increase of the temperature. After the reaction temperature reached 150° C., the inversion rate remained basically unchanged. At this time, the phenolic hydroxyl content was 4.42 mmol/g, and the inversion rate could reach 45.5%. This may be because when the temperature of the reaction system was lower than 150° C., the extract of cotton spinning black liquor was not sufficiently dissolved in the reaction system, and sank to the bottom of the polytetrafluoroethylene liner in blocks after the reaction, thus resulting in the low inversion rate.

### 2.2 Infrared Spectrum (FTIR) Analysis

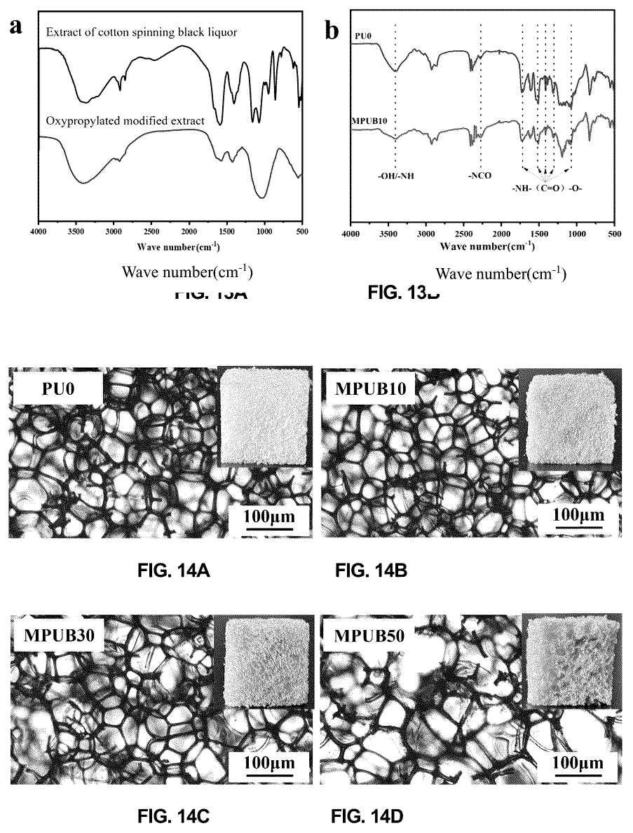

The molecular structures of the extracts of cotton spinning black liquor and the polyurethane foams before and after modification were analyzed using the infrared spectrometer. As shown in FIG. 13A, the oxypropylated modified extract of cotton spinning black liquor basically retained the original group absorption peaks. The peak at 3410 cm⁻¹ was the characteristic peak of the stretching vibration of O—H. As can be seen from the figure, the hydroxyl absorption peak of the modified extract was intensified, and the characteristic peaks near 1050 cm⁻¹ belonged to the stretching vibrations of C—O and C—O—C, indicating that the phenolic hydroxyls were mostly modified into alcoholic hydroxyls. Therefore, it was determined that the oxypropylation modification product was a polyether with hydroxyls, and could be used instead of petroleum-based polyol to react with isocyanate to prepare the polyurethane foam based on the extract of cotton spinning black liquor.

In the infrared spectrum characterization of the polyurethane foams in FIG. 13B, the absorption peaks at 3399 cm⁻¹ belonged to the stretching vibration of N—H and the stretching vibration of —OH, indicating that urethane bonds were present in the polyurethane foams. The peak at 1718 cm⁻¹ was associated with the characteristic vibration of the C═O group. The peak at 2273 cm⁻¹ was the unreacted —NCO group, which indicated that a small amount of isocyanate did not participate in the reaction. The peaks at 1406 cm⁻¹ and 1071 cm⁻¹ (C—N coupling, C—O extensional vibration) indicated the presence of the carbamate bonds, indicating that the extract of cotton spinning black liquor in the sample had sufficiently reacted with the isocyanate to form the carbamate structure. Compared with the infrared curve of PU0, the trend of the infrared curve of MPUB10 was basically the same and there was no new peaks, which indicated that the extract of cotton spinning black liquor did not chemically react with other components.

### 2.3 Optical Microscope Analysis

As can be seen from FIG. 14A to FIG. 14D, with the increase of the amount of the extract of cotton spinning black liquor, the color of the foam gradually became darker, the cell size became larger, the cell wall became thinner, and the loose cells supported each other, which indicated that the modified extract liquid of cotton spinning black liquor was dispersed uniformly. When the added amount reached 50%, the cells were nonuniform in size, irregular in shape and uneven distribution. This was mainly because the increase of side reactions in the foaming system greatly reduced the compatibility between the isocyanate and the polyol, causing the poor foaming effect, larger cell size and breakage of cell walls.

### 2.4 Apparent Density Analysis of Foams

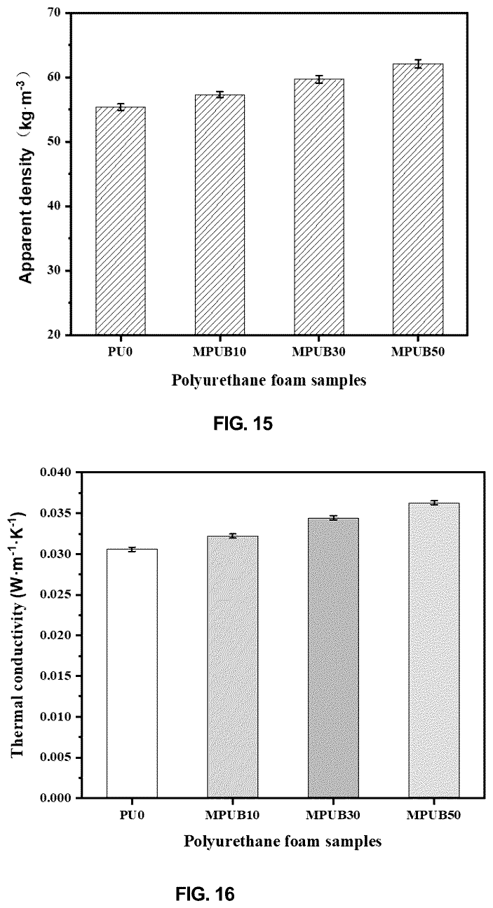

As can be seen from FIG. 15, with the increase of the polyol based on the extract of cotton spinning black liquor, the apparent density of the polyurethane foam gradually increased, and when the substitution rate was increased from 10% to 50%, the foam density was increased from 55.4 kg/m³ to 62.1 kg/m³, which was increased by 12.1%. This was mainly because when the substitution rate of the polyol increased, the compatibility between the isocyanate and the polyol in the whole foaming system decreased, thus causing the poor foaming effect, large voids between adjacent cells, breakage of cells, brittleness of the foam and reduction in the foam volume; and the added polyol based on the extract of cotton spinning black liquor increased the mass of the foam, thereby increasing the density of the foam. Since the required density of the polyurethane thermal insulation material is less than 60 kg/m³, the substitution rate of the polyol based on the extract of cotton spinning black liquor should be less than 30%, such that the foam density can be satisfactory.

### 2.5 Thermal Conductivity Analysis

The thermal conductivity of the polyurethane foam material reflects the thermal insulation performance of the material. A high thermal conductivity of the material indicates a high thermal conduction performance of the material. FIG. 16 shows thermal conductivities of different polyurethane foam samples. As can be seen from the figure, with the increase of the substitution rate of the extract of cotton spinning black liquor, the thermal conductivity shows an upward trend. The low thermal conductivity of PU0 was due to its regular structure, small and uniform cells, thick cell walls and close arrangement. The thermal conductivity of MPUB gradually increased with the increase of the substitution rate of the polyol, but all the MPUB foams meet the requirements for the thermal conductivity of building thermal insulation materials—0.02 W·m⁻¹·K⁻¹ to 0.05 W·m⁻¹·K⁻¹. Since the thermal conductivity of the foam is closely related to the cells and apparent density of the foam, as the substitution rate of the bio-based polyol increases, the dispersity of the reaction system decreases, and the thermal conductivity increases.

### 2.6 Thermogravimetric (TG) Analysis

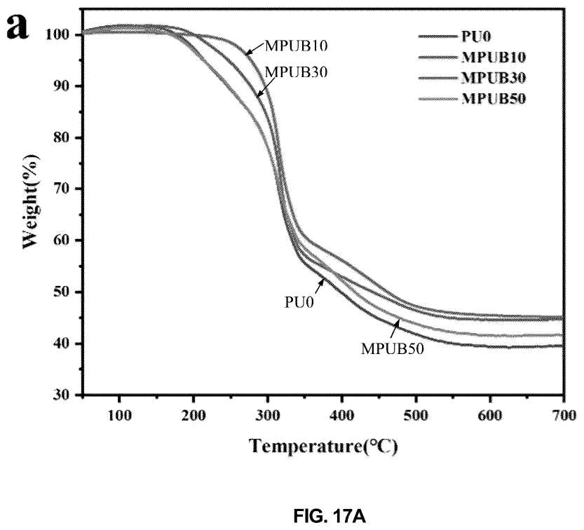

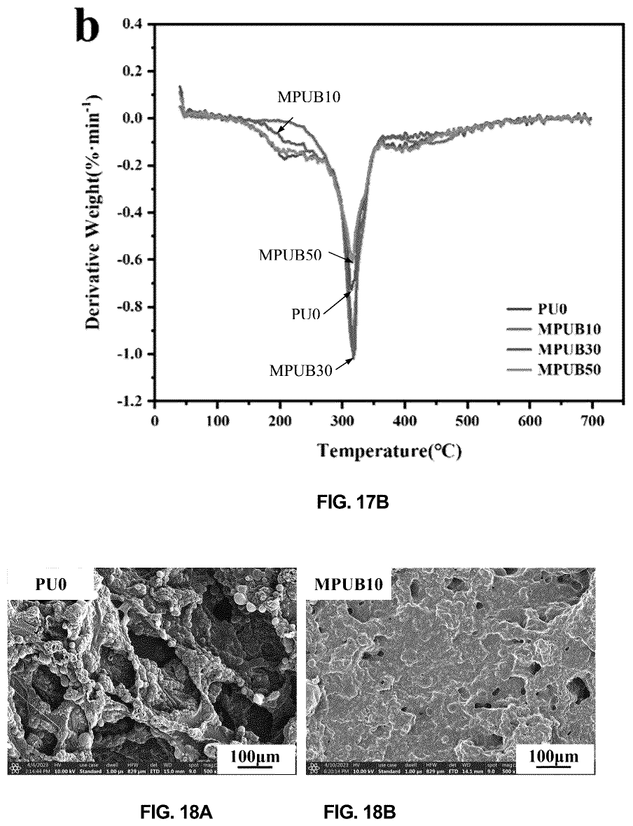

As can be seen from FIG. 17A, the polyurethane foams with the extract of cotton spinning black liquor had three significant weight loss stages. The first stage was 40° C.-260° C. In this stage, the total weight loss rate of each polyurethane sample was similar, which was mainly because of the volatilization of water in the foam. MPUB10 had the highest thermal decomposition temperature, which was about 60° C. higher than that of PU0. The second stage of thermal weight loss was 260° C. to 550° C. In this stage, the polyurethane foams exhibited significant thermal decomposition behaviors, i.e., significant weight loss and emission of a lot of gas. At 315° C., MPUB10 had the highest degradation rate of up to 10.39%·min⁻¹ (FIG. 17B), the main structure of the sample broke, and the sample was pyrolyzed into small molecule substances such as isocyanate and polyol. As the temperature increased, these small molecule substances were degraded into volatile substances such as CO₂. At this time, the pyrolysis of the main material of the foam was basically completed. The third stage was 550° C.-700° C. In this stage, the degradation rate of the foam gradually decreased. At this time, the remaining foam was the carbon layer which was difficult to degrade, and the degradation rate tended to be stable. At the temperature of 700° C., the total weight loss rate of MPUB10 was 55.12%, and the total weight loss rate of PU0 was 62.19%. This was because when the polyurethane foam was combusted, a carbon layer was formed on the surface of the material, and the extract of cotton spinning black liquor added reinforced the carbon layer to some extent. This carbon layer protected the interior material and had the effects of heat insulation and oxygen isolation, thus preventing flame from spreading to the inside. As a result, by adding the polyol based on the extract of cotton spinning black liquor, the polyurethane foam could have better heat resistance and thermal stability. However, when the added amount was too high, the regular structure of the foam may be damaged, and large cells formed were not conducive to the thermal stability and heat resistance of the foam.

TABLE 2
Thermogravimetric analysis of polyurethane foams with
different substitution rates of extract of cotton spinning black liquor

| | Maximum | | Maximum | | Maximum | |
|---|---|---|---|---|---|---|
| | thermal | Mass | thermal | Mass | degradation | Total |
| | weight loss | loss in | weight loss | loss in | rate in | weight |
| | temperature | first | temperature | second | second | loss at |
| | in first stage | stage | in second | stage | stage | 700° C. |
| Sample | (° C.) | (%) | stage (° C.) | (%) | (%/min) | (%) |
| PU0 | 203 | 3.23 | 314.89 | 53.65 | 5.46 | 62.19 |
| MPUB10 | 267 | 3.67 | 314.90 | 49.79 | 10.39 | 55.12 |
| MPUB30 | 222 | 2.13 | 317.38 | 52.07 | 7.90 | 57.15 |
| MPUB50 | 208 | 4.21 | 315.80 | 52.11 | 5.26 | 59.56 |

### 2.7 Scanning Electron Microscope (SEM) Analysis

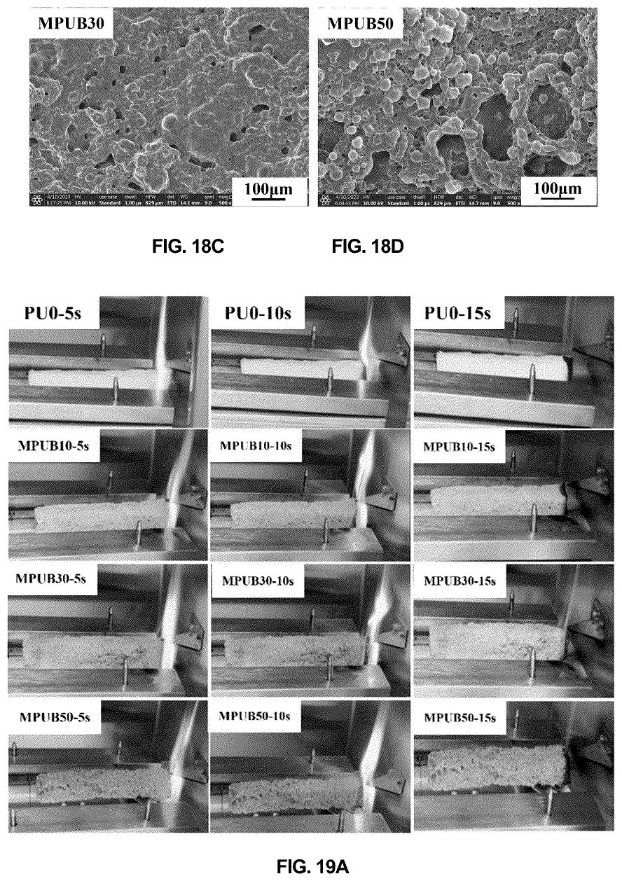

As shown in FIG. 18A to FIG. 18D, the surface of the residual carbon of the PU0 sample had large cells. When the polyurethane foam was combusted, the generated flame and heat, and O₂ in the air could be transported to the inside of the material through these channels, so that the inside of the foam was combusted and decomposed, causing the reduction of the residual carbon. The surface of the carbon layer formed after the polyurethane foam prepared by partially substituting polyol with the extract of cotton spinning black liquor was combusted was smooth and continuous, there were significantly fewer cells and gaps, and the firmness of the residual carbon was improved, which could function as an effective protective film to prevent heat, flammable gas and oxygen from diffusing to the unburned area, thereby preventing more material from degradation and improving the flame retardancy of the material. The surface of MPUB50 also had a few large cells. This was mainly because when the added amount of the extract of cotton spinning black liquor was large, the surface of the formed polyurethane foam was more fragmented, and the apparent density was high, which is consistent with the conclusion of the thermogravimetric analysis.

### 2.8 Flammability Analysis

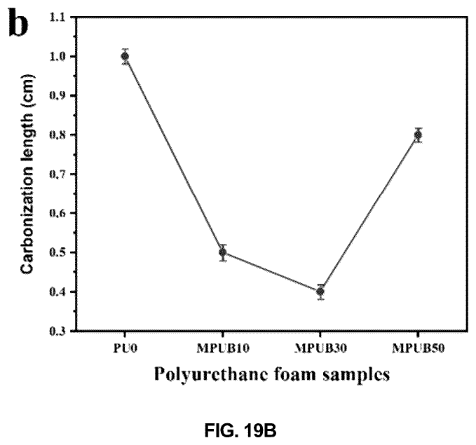

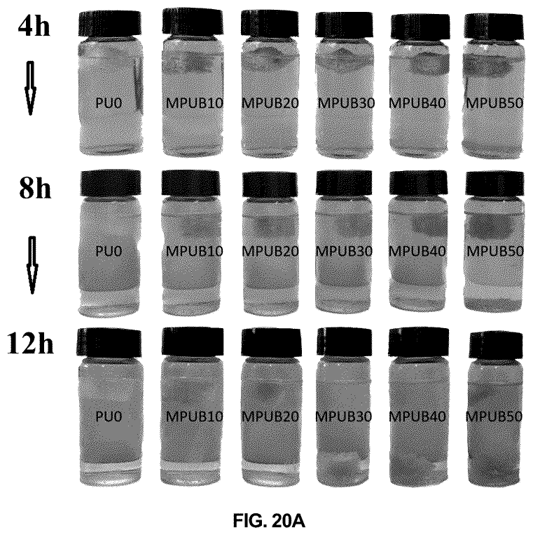

FIG. 19A shows pictures of polyurethane foam sample bars PU0, MPUB10, MPUB30 and MPUB50 respectively at 5, 10 and 15 s in a horizontal burning test. As can be seen, no dripping or breaking occurred during the combustion of the materials, and all the materials had good carbon formation effects and fire resistance, and could be self-extinguishing after leaving the fire within 15 s of combustion. FIG. 19B shows lengths of carbonized parts of the sample bars after the flame went out. From PU0 to MPUB50, the carbonization length first decreased and then increased. MPUB30 had the smallest carbonization length. Compared with PU0, the length of the carbonized part decreased from 1 cm to 0.4 cm. The addition of the extract of cotton spinning black liquor could effectively inhibit the flame from spreading on the surface of the polyurethane foam, thereby improving the flame retardancy of the material. With the increase of the amount of the extract of cotton spinning black liquor, the surface of the material became more fragmented, and the cell walls became thinner, which was conducive to the infiltration of air and the increase of the carbonization length. This is consistent with the characterization above.

### 2.9 Degradability Analysis

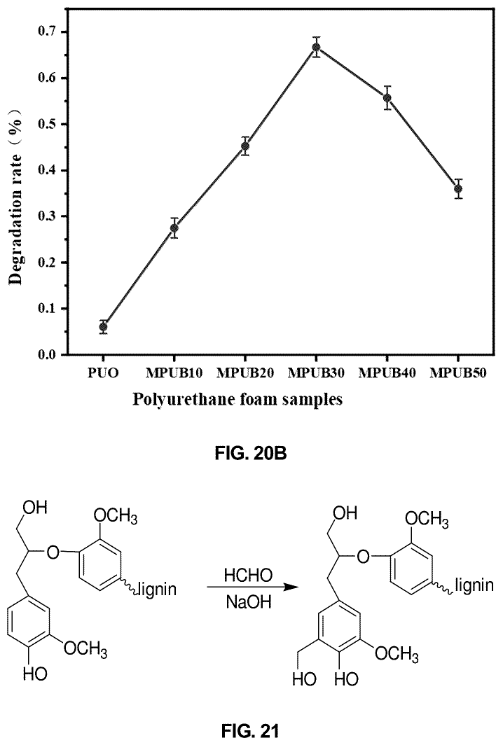

FIG. 20A shows pictures of degradation of the polyurethane foam samples in an NaOH—CH₃OH solution at 4, 8 and 12 h. As can be seen from the figure, the polyurethane foam samples had good degradability. The foam samples with the original size of 1×1×1 cm³ swelled first, and then decomposed to produce gray flocs settling at the bottom of sample bottles. After 12 h of degradation, the foam cubes were mostly degraded. The degradation residues were collected and weighed. The degradation rate of each sample was calculated (FIG. 20B). MPUB30 had the highest degradation rate, and its degradation rate at 12 h could reach 66.7%. PU0 was basically not degraded. As a result, the addition of the extract of cotton spinning black liquor was conducive to the improvement of the degradability of the polyurethane foam.

Based on the above, in this example, after the extract of cotton spinning black liquor used as the raw material was subjected to oxypropylation modification, 45.5% of phenolic hydroxyls were converted into alcoholic hydroxyls at 150° C., and FT-IR was carried out for verification. Then, the polyurethane foams were prepared by partially substituting polyether polyol. When the substitution rate was 30%, the surface of the material had uniform cell size and regular structure, and both the apparent density and the thermal conductivity met the national standard. The TG analysis showed that its thermal decomposition temperature was significantly increased. As can be seen from the SEM image of the carbon layer, the material had good carbon formation effect, and the surface of the carbon layer was continuous, dense and smooth rather than with huge cracks and cells. In the horizontal burning test, no dripping or breaking occurred, and the length of the carbonized part was decreased from 1 cm to 0.4 cm, indicating a significant decrease of the carbonization length. In the degradation test, the degradation rate at 12 h was up to 66.7%. As a result, the addition of the extract of cotton spinning black liquor was conducive to the improvement of the thermal stability, flame retardancy and degradability of the polyurethane foam.

### Part Three: Preparation of Polyurethane Foam Using Hydroxymethyl Modified Extract of Cotton Spinning Black Liquor

### 1. Experimental Part

### 1.1 Main Raw Materials and Reagents

Sodium thiosulfate (analytically pure) was purchased from Sinopharm Chemical Reagent Co., Ltd., and the sources and specifications of the other raw materials and reagents were the same as in Part One and Part Two.

### 1.2 Main Equipment and Instruments

JA5003 electronic balance; DF-101S heat-gathering magnetic stirrer; GZX-9246 MBE digital-display blast drying oven; BA210 optical microscope; YG(B)810D horizontal burning tester; H1850 high-speed desktop centrifuge; PHS-3C PH meter; SHB-III circulating-water vacuum pump; HITACHI SU8020 scanning electron microscope; TPS2500S thermal constant analyzer; Nicolet iS10 Fourier infrared spectrometer; TA449F3 thermogravimetric analyzer.

### 1.3 Sample Preparation

### 1.3.1 Hydroxymethyl Modification of Extract of Cotton Spinning Black Liquor

Hydroxymethyl modification could increase the concentration of alcoholic hydroxyl in the extract of cotton spinning black liquor: 50 g of extract of cotton spinning black liquor was weighed, dried in the 80° C. digital-display blast drying oven for 48 h, and pulverized in the mechanical pulverizer (then passed through a 60-mesh screen). 20 g of formaldehyde and 20 g of distilled water were added and uniformly mixed. The mixture was put into a three-necked flask and refluxed at 80° C. for condensation for 5 h. Then, the pH of the solution was adjusted to 2 with HCl. The precipitate was washed to neutral by centrifugation, dried and ground to obtain the hydroxymethylated extract of cotton spinning black liquor. The reaction process is shown in FIG. 21. The preparation method of the extract of cotton spinning black liquor was the same as that in Part Two (the extract of cotton spinning black liquor obtained by acid precipitation at the pH of 7.0 could obtain better modification effects during the hydroxymethyl modification than the extract of cotton spinning black liquor obtained by acid precipitation at the pH of 4.0).

### 1.3.2 Preparation of Polyurethane Foams

The polyurethane foams were prepared according to the formulae in Table 3 by one-step foaming. Certain amounts of polyether polyol and hydroxymethylated extract of cotton spinning black liquor, 0.03 g of dibutyltin dilaurate, 0.15 g of distilled water, 0.15 g of foam stabilizer and 2.25 g of aluminum hypophosphite were stirred at 1000 rpm for 30 s such that all the components were uniformly mixed. 3.5 g of isocyanate PMDI was accurately weighed and quickly added to the mixture, and uniformly mixed. After foaming, the expanded material was poured into a mold and allowed to continue foaming at 50° C. for 1 h. The resulting product was cooled to room temperature, and cured in an 80° C. oven for 24 h to obtain the polyurethane foam with the hydroxymethylated extract of cotton spinning black liquor. 6 different polyurethane foams with the hydroxymethylated extract of cotton spinning black liquor were prepared according to different added amounts of the hydroxymethylated extract of cotton spinning black liquor. In this example, the foams with 0%, 10%, 20%, 30%, 40% and 50% of the hydroxymethylated extract of cotton spinning black liquor were respectively named PUF0, MPUF10, MPUF20, MPUF30, MPUF40 and MPUF50.

TABLE 3
Raw materials for preparing polyurethane foams with hydroxymethylated
extract of cotton spinning black liquor

| | | Hydroxymethylated extract | |
|---|---|---|---|
| | Polyether | of cotton spinning black | |
| Name | polyol/g | liquor/g | Substitution rate/% |
| PUF0 | 3 | 0 | 0 wt % |
| MPUF10 | 2.7 | 0.3 | 10 wt % |
| MPUF20 | 2.4 | 0.6 | 20 wt % |
| MPUF30 | 2.1 | 0.9 | 30 wt % |
| MPUF40 | 1.8 | 1.2 | 40 wt % |
| MPUF50 | 1.5 | 1.5 | 50 wt % |

### 1.4 Performance Testing and Structural Characterization

### 1.4.1 Determination of Hydroxymethyl Content

The determination was carried out with reference to GB/T14074-2006. First, the free formaldehyde content was determined. Free formaldehyde in the test sample easily reacted with hydroxylamine hydrochloride, and the hydrochloric acid formed by the reaction was titrated with sodium hydroxide. 1 g of test sample was accurately weighed and put into a 250 mL beaker. 50 mL of distilled water and 1 mol/L sodium hydroxide were added such that the test sample was sufficiently dissolved. The pH electrode was inserted into the solution, and the pH of the solution was adjusted to 3.5 with a 1 mol/L hydrochloric acid solution and 0.1 mol/L hydrochloric acid solution. 10 mL of 10% hydroxylamine hydrochloride solution was added dropwise and stirred for 10 min, and then the pH of the solution to be tested was quickly titrated to 3.5 with a 0.1 mol/L hydrochloric acid solution. At the same time, a blank experiment was carried out. The determination was carried out in 3 replicates. The mass fraction of free formaldehyde was calculated according to formula (3-1):

$$W = \frac{( V - {V}_{0} ) \times 0.03003 \times C}{m} \times 100 \% \qquad ( 3 - 1 )$$

where W is the mass fraction of free formaldehyde in %; V is the volume of the sodium hydroxide solution consumed by titrating the test sample in mL; V₀ is the volume of the sodium hydroxide solution consumed by the blank sample in mL; C is the concentration of the sodium hydroxide solution in mol/L; m is the mass of the test sample in g; and 0.03003 is the mass of formaldehyde equivalent to 1.0 mL sodium hydroxide solution (0.1 mol/L) in g.

After the extract of cotton spinning black liquor was subjected to hydroxymethyl modification, the hydroxymethyl (—CH₂OH) reacted with iodine in the alkaline medium, and the residual iodine was titrated with sodium thiosulfate, so that the hydroxymethyl content could be measured. 0.1 g of sample to be tested was accurately weighed and put into an iodine number flask. 50 mL of distilled water was added first. After shaking well, 25 mL of 0.1 mol/L iodine solution and 10 mL of 2 mol/L sodium hydroxide solution was sequentially added. After shaking well, the solution was allowed to stand for 30 min. Then, 10 mL of 4 mol/L hydrochloric acid solution and a starch indicator were added. Finally, the solution was titrated with a sodium thiosulfate standard solution until the blue color disappeared. At the same time, a blank experiment was carried out, and the determination was carried out in 3 replicates. The hydroxymethyl mass fraction was calculated according to formula (3-2):

$$M = [ \frac{( {V}_{1} - {V}_{2} ) \times 0.015 \times c}{m} \times 100 - W ] \times 1.03 \qquad ( 3 - 2 )$$

where M is the hydroxymethyl mass fraction in %; V₁ is the volume of the standard solution consumed by the blank sample in mL; V₂ is the volume of the standard solution consumed by the test sample in mL; c is the concentration of the sodium thiosulfate standard solution in mol/L; m is the mass of the sample in g; W is the free formaldehyde content in %; 0.015 is the corrected value; and 1.03 is the ratio of the hydroxymethyl molecular mass to the formaldehyde molecular mass.

### 1.4.2 Other Test and Analysis Methods

FTIR analysis: The infrared spectrum of the sample was determined using a Nicolet 380 Fourier infrared (FT-IR) spectrometer. The sample was ground, and mixed with KBr according to a ratio of 1:100, and the mixture was dried in an infrared drying oven and pelletized. The scan range was 400-4000 cm⁻¹, and the number of scans was 32.

Morphology analysis: The macroscopic morphology of the polyurethane foam was observed using iPhone 14. The microscopic morphology of the polyurethane foam with the hydroxymethylated extract of cotton spinning black liquor was observed using the BA210 optical microscope. The foam sample was sliced, and the slice was put on a glass slide. Then, the coverslip was gently mounted, and the micrograph was collected through accessories. The magnification was 40 times.

Apparent density test: The apparent density was tested according to the method in GB/T6343-2009 “Cellular Plastics and Rubbers-Determination of Apparent (Bulk) Density”. The foam sample was cut into a 2 cm×2 cm×2 cm cube. The side length of the cube was measured by averaging values of three positions. The volume of the sample was calculated. The mass of the sample was weighed with the analytical balance (accurate to 0.001 g), and the density of the material was calculated.

Scanning electron microscope (SEM): The surface morphology of the flame-retardant polyurethane foam based on the hydroxymethylated extract of cotton spinning black liquor was observed using the Hitachi SU8020 scanning electron microscope. The residual carbon after the sample was completely combusted was sliced, and the slice was fixed with a conductive adhesive. A thin metal coating was deposited, and then the residual carbon was observed.

TG analysis: The thermal stability of the sample was tested using the TA449F3 thermogravimetric analyzer in a nitrogen atmosphere. The heating range was 40° C. to 700° C., the heating rate was 10° C./min, and the gas flow rate was 10 mL/min.

Thermal conductivity characterization: The thermal conductivity was characterized using the Disk TPS2500S thermal conductivity analyzer according to a transient plane heat source method.

Flammability test: The testing was carried out with reference to GB/T8332-2008 “Test Method for Flammability of Cellular Plastic-Horizontal Burning Method”. The sample to be tested was cut into a size of 1.5 cm×10 cm×10 cm. A butane torch and a combustion tester were used. The sample was combusted at the flame for 15 s, and then the butane torch was turned off. The length of the sample after combustion was measured.

Degradability test: A 0.5 mol/L sodium hydroxide aqueous solution was prepared, and then mixed with a methanol solution according to a volume ratio of 1:1. The prepared polyurethane foam was cut into a 1 cm×1 cm×1 cm cube. After the mass of the cube was weighed accurately, the cube was put into a sample flask filled with the NaOH—CH3OH aqueous solution, and the sample flask was placed in a 60° C. water bath. The degradation residues were taken out respectively at 4, 8 and 12 h, and then dried and weighed. The degradation rates of the sample were calculated according to formula (3-3).

$$R = ( \frac{{M}_{a}}{{M}_{0}} ) \times 100 \% \qquad ( 3 - 3 )$$

where R is the degradation rate in %; M₀ is the original mass of the polyurethane foam in g; and Mₐ is the mass of the residue after degradation in g.

### 2. Results and Discussion

### 2.1 Analysis of Hydroxymethyl Modification Results

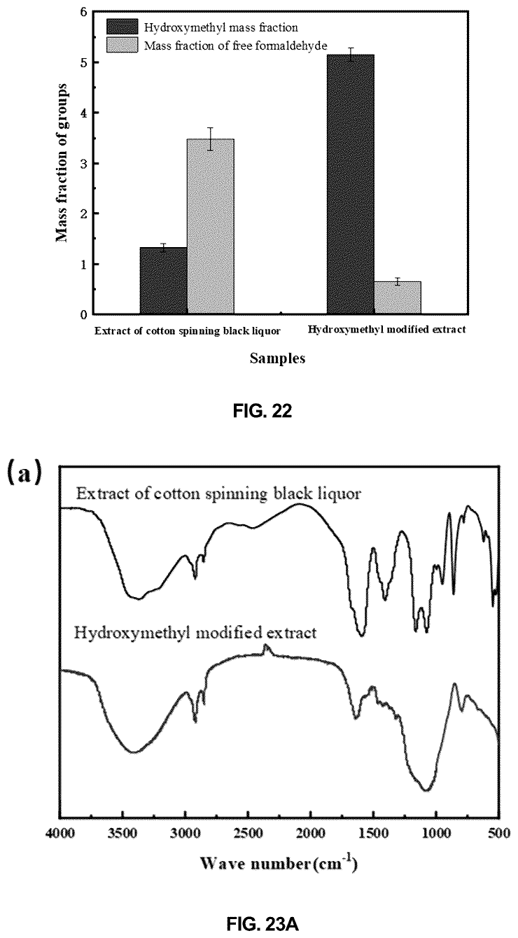

FIG. 22 shows test results of hydroxymethyl contents and free formaldehyde contents of the extract of cotton spinning black liquor before and after modification. As can be seen from the figure, the hydroxymethyl mass fraction of the modified extract of cotton spinning black liquor was increased from 1.32% to 5.15%, and the free formaldehyde content was significantly reduced, indicating that the hydroxymethylation modification was conducive to the subsequent preparation of the polyurethane foam.

### 2.2 Infrared Spectrum (FTIR) Analysis

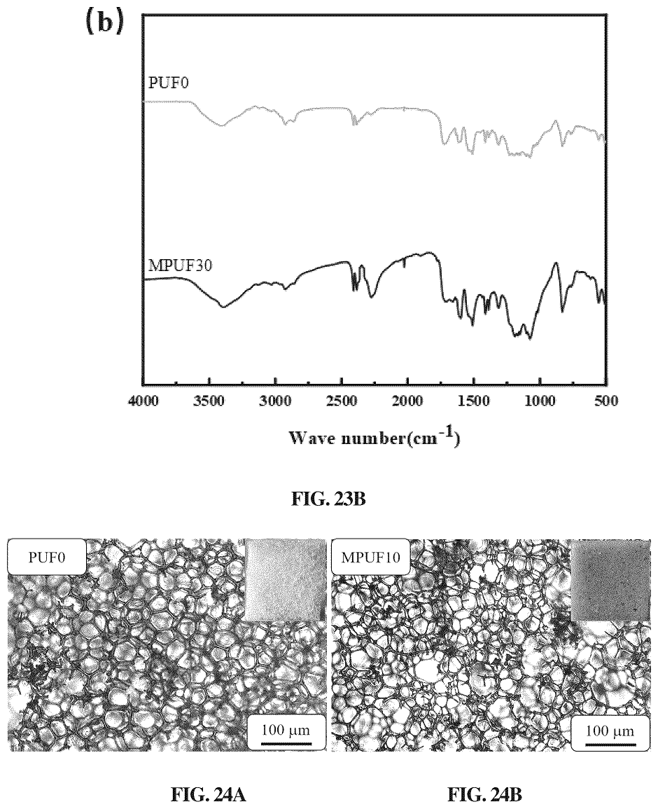

FIG. 23A shows infrared spectra of samples of the extract of cotton spinning black liquor and the hydroxymethylated modified extract. As can be seen from the figure, the hydroxymethyl modified extract of cotton spinning black liquor basically retained the original group absorption peaks. The broad peak at 3500 cm⁻¹ was due to the characteristic absorption peak of hydroxyl, the peaks at 2922 cm⁻¹ and 2852 cm⁻¹ were respectively due to the antisymmetric stretching vibrations of methylene, the absorption peaks at 1646 cm⁻¹ and 1507 cm⁻¹ were due to the infrared characteristic absorption peaks of the benzene ring, and the peak at 1088 cm⁻¹ was due to the absorption band generated by C—O in (—CH₂OH). As can be seen, the peaks of the hydroxymethyl modified extract of cotton spinning black liquor were significantly intensified. FIG. 23B shows infrared spectra of polyurethane foams PUF0 and MPUF30. As can be seen, the trends of the two curves were basically the same. The absorption peaks at 3394 cm⁻¹ were due to the stretching vibrations of hydroxyl, the peaks at 2927 cm⁻¹ were due to the stretching vibrations of methyl and methylene in the cotton spinning black liquor, the absorption peaks at 1718 cm⁻¹ and 1511 cm⁻¹ were due to the skeletal vibrations of the aromatic ring, and the peaks at 1075 cm⁻¹ were the characteristic peaks of hydroxymethyl. Compared with PUF0, the peaks of the PUF30 were significantly broader, indicating that there were more hydroxymethyl groups in the polyurethane foam prepared using the extract of cotton spinning black liquor.

### 2.3 Microscopic Morphology Analysis

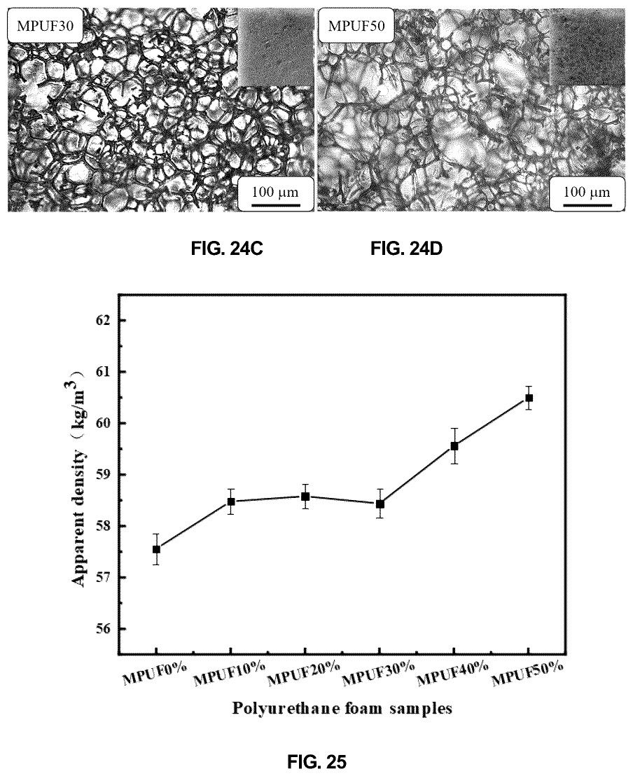

FIG. 24A to FIG. 24D are respectively micrographs and macrographs of the polyurethane foams. As can be seen from the figures, with the increase of the added amount of the hydroxymethylated extract of cotton spinning black liquor, the color of the polyurethane foam gradually became darker, the surface of the polyurethane foam became fragmented from a uniform and orderly structure, the cell size became larger, and the cell wall became thinner, which was mainly because the added extract of cotton spinning black liquor increased the polydispersity of the raw material and part of the substitute was dissolved. Moreover, part of cells on the MPUF50 were produced when cutting the sample.

### 2.4 Apparent Density Characterization

FIG. 25 shows an apparent density curve of polyurethane foam samples with different substitution rates. As can be seen from the figure, with the increase of the added amount of the extract of cotton spinning black liquor, the apparent density of the polyurethane foam also increased. This was mainly because the addition of the extract of cotton spinning black liquor could increase the viscosity of the reaction system and destroy the uniformity of the reaction system, causing poor dispersity and poor foaming effect. Thus, large voids were generated between adjacent cells, such that the foam became brittle and its volume became smaller. However, the addition of the extract of cotton spinning black liquor could increase the mass of the foam, so as to increase the density of the foam. Since the required density of the polyurethane thermal insulation material is less than 60 kg/m³, the substitution rate of the polyol based on the extract of cotton spinning black liquor should be less than 40%, such that the foam density can be satisfactory.

### 2.5 Scanning Electron Microscope (SEM) Analysis

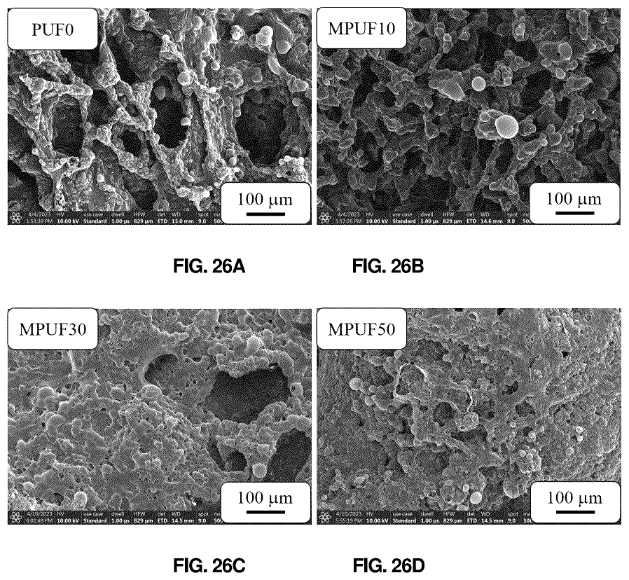

The residual carbon after the polyurethane foam was completely combusted was characterized using SEM. The results are shown in FIG. 26A to FIG. 26D. As can be seen from the figures, the surface of the residual carbon of PUF0 had many large voids connected inside and outside, and the foam surface had large openings and uneven distribution, so that large amounts of oxygen and heat could be exchanged inside and outside, which contributed to the combustion. The surface of the carbon layer of MPUF30 became very dense and uniform, the voids on the carbon layer were smaller, the area of openings on the surface was smaller, and the bubbles inside were smaller, which interfered with the gas exchange inside and outside the foam and improved the flame retardancy of the foam to some extent. This was mainly because the carbon layer could be formed after the extract of cotton spinning black liquor was combusted, and this carbon layer isolated external oxygen and prevented heat conduction during the pyrolysis process, thereby protecting the unburned part below and achieving good flame-retardant effect.

### 2.6 Thermogravimetric (TG) Analysis

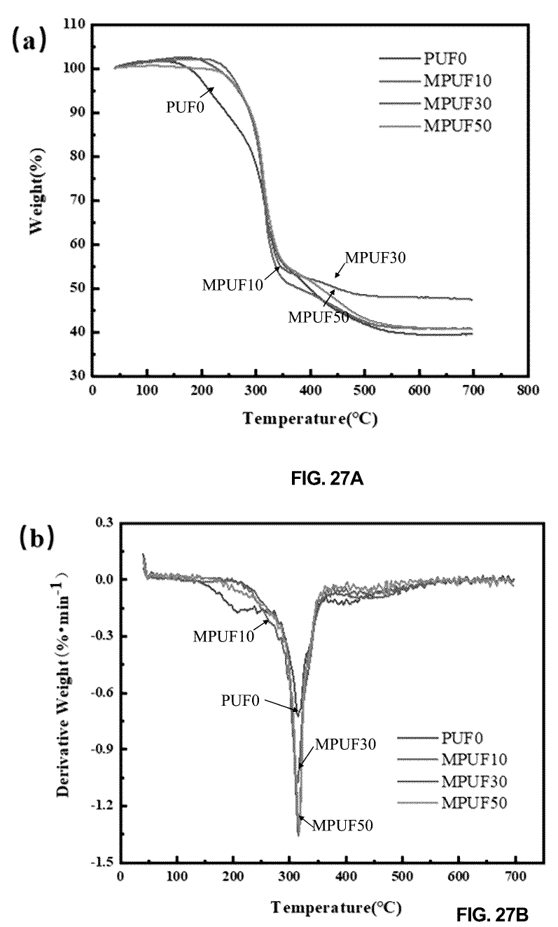

As can be seen from FIG. 27A to FIG. 27B, the polyurethane foams prepared with different substitution rates of the extract of cotton spinning black liquor all showed a one-step weight loss process, but with slightly different thermal decomposition rates. The whole thermal decomposition process was divided into: a drying stage (0-250° C.): this stage was mainly the process of evaporation of water in the polyurethane foam and slow dewatering and carbonization; a thermal degradation stage (250-520° C.): in this stage, the thermal decomposition rate quickly increased, which was mainly caused by the pyrolysis and volatilization of the polyurethane foam; and a carbonization stage (520-700° C.): the thermal weight loss rate decreased, and intermolecular cross-linking and carbonization occurred such that small molecules were removed; and in this stage, the mass basically remained unchanged, indicating that the residual carbon was very stable and difficult to oxidize and decompose. The initial decomposition temperature of the PUF0 polyurethane foam was 194° C., the maximum degradation rate was 5.46%/min, and the residual carbon at 700° C. was 37.81%. In contrast, the initial thermal decomposition of the MPUF30 was significantly higher, reaching 268° C., the maximum degradation rate was 12.28%/min, and the residual carbon at 700° C. was 47.47%. This was because after the hydroxymethylated extract of cotton spinning black liquor was added, the carbon content in the carbon layer generated after complete combustion continuously increased, so that the firmness of the carbon layer during the combustion of the polyurethane foam was increased, which stopped the combustion of the interior material and increased the difficulty in the thermal degradation of the polyurethane foam, thereby protecting the polyurethane foam material. As a result, the addition of the hydroxymethylated extract of cotton spinning black liquor improved the thermal stability of the polyurethane foam, and the foam prepared using the hydroxymethylated extract of cotton spinning black liquor could be used in an environment with a high temperature.

TABLE 4
Thermal degradation data of polyurethane foams

| | | | Maximum | | |
|---|---|---|---|---|---|
| | Maximum | | thermal weight | | |
| | thermal weight | | loss | | |
| | loss | Mass loss | temperature in | Mass loss in | Residual |
| | temperature in | in first | second stage | second | carbon at |
| Sample | first stage (° C.) | stage (%) | (° C.) | stage (%) | 700° C. (%) |
| PUF0 | 194 | 2.97 | 312 | 55.77 | 37.81 |
| MPUF10 | 262 | 2.55 | 316 | 55.05 | 40.83 |
| MPUF30 | 268 | 3.63 | 317 | 53.23 | 47.47 |
| MPUF50 | 263 | 4.86 | 315 | 46.86 | 40.80 |

### 2.7 Thermal Conductivity Analysis

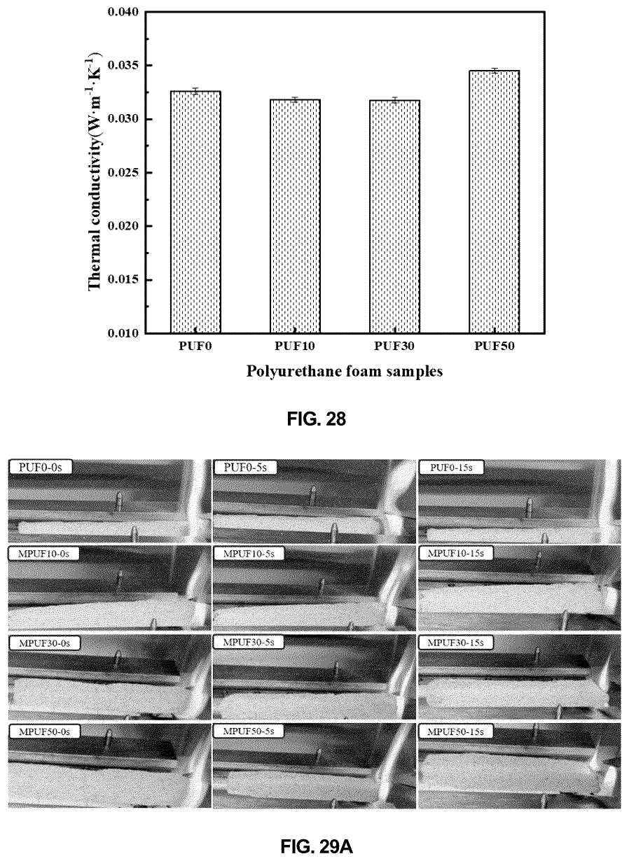

The thermal conductivities of the polyurethane foams are shown in FIG. 28. The thermal conductivities were mainly dependent on the cell structure of the foam. As can be seen, all the polyurethane foams prepared using the extract of cotton spinning black liquor met the thermal conductivity requirement (0.02 W·m⁻¹·K⁻¹ to 0.05 W·m⁻¹·K⁻¹) for thermal insulation materials. When the added amount of the extract of cotton spinning black liquor was lower than 30%, there was no significant influence on the thermal conductivity of the polyurethane foam, which may be because the small added amount of the extract of cotton spinning black liquor could be uniformly mixed with the raw materials such that the prepared polyurethane foam had uniform cell size and thick cell wall. When the substitution rate reached 50%, the thermal conductivity of the polyurethane foam was increased to some extent, which was mainly because part of the extract of cotton spinning black liquor could not be dissolved in the reaction system due to its high substitution rate and the foaming system could not sufficiently react, causing poor dispersity during the preparation of the foam and fragmented cell structure. This was consistent with the structure observed under the optical microscope.

### 2.8 Flammability Test

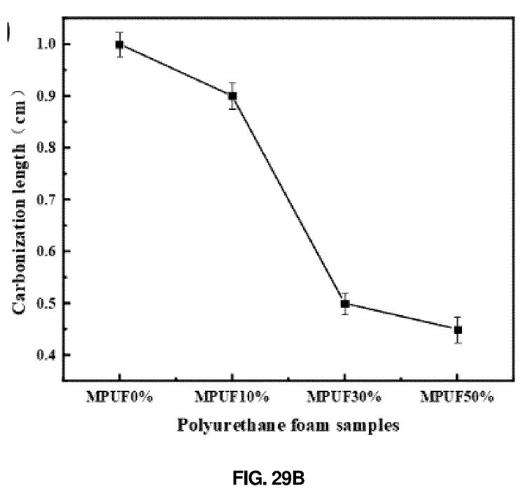

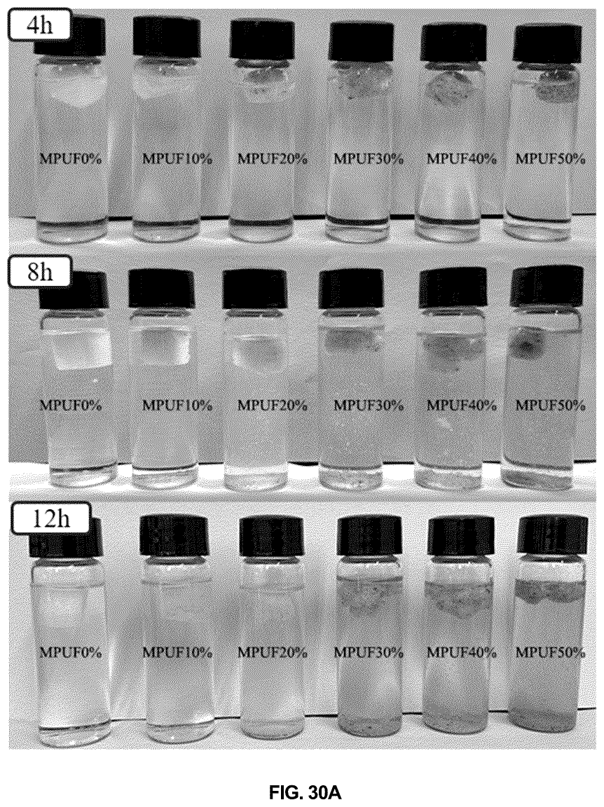

The fire resistance of the PUF0, MPUF10, MPUF30 and MPUF50 samples was observed through a horizontal burning test. The pictures of combustion are shown in FIG. 29a. The carbonization lengths of the polyurethane foams were also recorded (FIG. 29B). As can be seen from FIG. 29A, after the polyurethane foams based on the cotton spinning black liquor substitute were combusted for 15 s, the flame significantly became smaller, and all the polyurethane foams could be self-extinguishing after leaving fire. Moreover, there were no dripping or breaking during the combustion process, and all the polyurethane foams had good carbon formation effects. As can be seen from FIG. 29B, the addition of the hydroxymethylated extract of cotton spinning black liquor could effectively inhibit the flame from spreading on the surface of the material. Compared with PUF0, the carbonization length of MPUF30 was decreased from 1 cm to 0.5 cm. The carbon formation effect of the extract of cotton spinning black liquor as a carbon source could improve the fire resistance of the polyurethane foam material during the combustion process.

### 2.9 Degradability Analysis

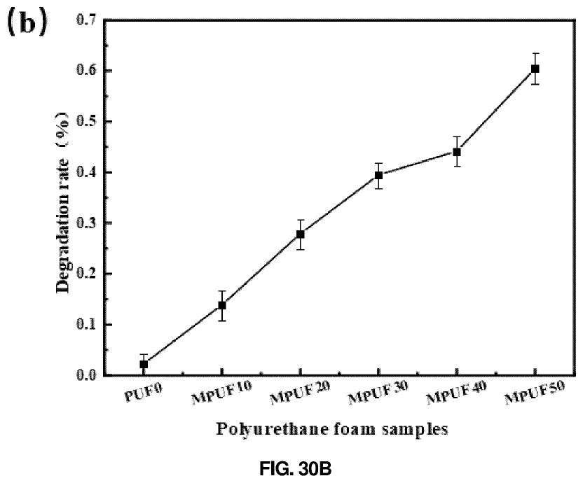

Degradation of the extract of cotton spinning black liquor is achieved by the breaking of ether bonds in an alkaline solution, but simply a single alkaline solution enters the foam slowly. In this example, a mixed solution of low-boiling methanol miscible with an alkaline solution and an alkaline solution was used to determine the degradability of the polyurethane foam with the hydroxymethylated extract of cotton spinning black liquor. The pictures of degradation are shown in FIG. 30A. The polyurethane foams with an original size of 1 cm×1 cm×1 cm swelled first, and then were dissolved gradually. As time went on, a small amount of solid powder appeared at the bottom of the sample flask. The degradation rates at 12 h are shown in FIG. 30B. PUF0 was basically not degraded. With the increase of the substitution rate of the extract of cotton spinning black liquor, the degradation rate gradually increased. The degradation rates of MPU30 and MPUF50 were respectively 39.5% and 60.5%. As a result, the addition of the extract of cotton spinning black liquor was conducive to the improvement of the degradability of the polyurethane foam.

Based on the above, in this example, the extract of cotton spinning black liquor used as the raw material was subjected to hydroxymethyl modification with formaldehyde, and then the polyurethane foam materials were prepared by partially substituting polyether polyol by one-step foaming. The structures of the polyurethane foam materials were characterized. The results showed that through the hydroxymethyl modification, the hydroxyl content of the extract of cotton spinning black liquor was significantly increased, and FT-IR was carried out for verification. When the substitution rate of polyether polyol was 30%, the prepared polyurethane foam had uniformly distributed cells on the surface and a low apparent density. After the polyurethane foam was completely combusted, as can be seen under the scanning electron microscope (SEM) that the carbon layer became very dense and uniform, and the voids on the carbon layer became smaller, indicating good flame retardancy. The initial thermal decomposition temperature could reach 268° C., and the residual carbon at 700° C. was 47.47%, indicating excellent thermal stability. The thermal conductivity of the polyurethane foam met the requirement for building thermal insulation materials. In the horizontal burning test, after 15 s, the polyurethane foam could be self-extinguishing after leaving fire. The carbon formation effect was good. The carbonization length was decreased to 0.5 cm. The polyurethane foam had excellent degradability.

What is claimed is:

1. A method for preparing a polyurethane foam using an extract of cotton spinning liquor, black comprising the following steps:
step (1): extracting biomass in cotton spinning black liquor by acid precipitation to obtain the extract of cotton spinning black liquor;
step (2): pretreating the extract of cotton spinning black liquor, and uniformly mixing the pretreated extract of cotton spinning black liquor with a polyether polyol to obtain a mixed raw material; and
step (3): preparing the polyurethane foam from the mixed raw material, dibutyltin dilaurate, distilled water, a foam stabilizer, aluminum hypophosphite and an isocyanate by one-step foaming.

2. The method for preparing a polyurethane foam using an extract of cotton spinning black liquor according to claim 1, wherein in step (1), a method for extracting the biomass in the cotton spinning black liquor by acid precipitation comprises: adding dropwise phosphoric acid into the cotton spinning black liquor with a Baume scale of 3-20° Be′ while stirring to adjust a pH of the cotton spinning black liquor to 4.0-7.0 for precipitation; and after the precipitation is completed, drying the precipitate obtained by centrifugal separation to obtain the extract of cotton spinning black liquor.

3. The method for preparing a polyurethane foam using an extract of cotton spinning black liquor according to claim 2, wherein in step (1), the method for extracting the biomass in the cotton spinning black liquor by acid precipitation comprises: adding dropwise phosphoric acid into the cotton spinning black liquor with a Baume scale of 5-10° Be′ while stirring to adjust the pH of the cotton spinning black liquor to 4.0 or 7.0 for precipitation; and after the precipitation is completed, carrying out centrifugal separation on the resulting mixture at 5000 rpm for 5 min to obtain a precipitation product, and drying the precipitation product at 60-80° C. for 72-84 h to obtain the extract of cotton spinning black liquor.

4. The method for preparing a polyurethane foam using an extract of cotton spinning black liquor according to claim 2, wherein in step (2), a method for pretreating the extract of cotton spinning black liquor comprises: pulverizing the extract of cotton spinning black liquor, passing the pulverized extract of cotton spinning black liquor through a 60-mesh screen, and taking the undersize as the pretreated extract of cotton spinning black liquor.

5. The method for preparing a polyurethane foam using an extract of cotton spinning black liquor according to claim 2, wherein in step (2), the method for pretreating the extract of cotton spinning black liquor comprises:
step (2-1): pulverizing the extract of cotton spinning black liquor, and passing the pulverized extract of cotton spinning black liquor through a screen to obtain an extract powder of cotton spinning black liquor;
step (2-2): uniformly mixing the extract powder of cotton spinning black liquor, propylene oxide, anhydrous glycerol, potassium hydroxide and acetone to obtain an oxypropylation modification mixed system; and
step (2-3): carrying out an oxypropylation modification reaction on the oxypropylation modification mixed system in a high-pressure reactor, and after the reaction is completed, cooling the resulting product to room temperature to obtain an oxypropylated modified extract of cotton spinning black liquor, which is the pretreated extract of cotton spinning black liquor.

6. The method for preparing a polyurethane foam using an extract of cotton spinning black liquor according to claim 5, wherein in step (2-1), the extract powder of cotton spinning black liquor is the undersize obtained after the extract of cotton spinning black liquor is pulverized and passed through a 60-mesh screen;
in step (2-2), a mass ratio of the extract powder of cotton spinning black liquor to the propylene oxide to the anhydrous glycerol to the potassium hydroxide to the acetone is 4:4:1.11:0.1:8; and
in step (2-3), the oxypropylation modification reaction is carried out at a temperature of 130-170° C. for 2 h.

7. The method for preparing a polyurethane foam using an extract of cotton spinning black liquor according to claim 2, wherein in step (2), the method for pretreating the extract of cotton spinning black liquor comprises:
step (2-1): drying and pulverizing the extract of cotton spinning black liquor, and passing the pulverized extract of cotton spinning black liquor through a screen to obtain an extract powder of cotton spinning black liquor;
step (2-2): after uniformly mixing the extract powder of cotton spinning black liquor, formaldehyde and distilled water, refluxing the mixture in a three-necked flask to obtain a hydroxymethyl modification mixed system; and
step (2-3): adjusting a pH of the hydroxymethyl modification mixed system to 2 with hydrochloric acid, washing the precipitate to neutral by centrifugation, and finally, drying and pulverizing the precipitate to obtain a hydroxymethyl modified extract of cotton spinning black liquor, which is the pretreated extract of cotton spinning black liquor.

8. The method for preparing a polyurethane foam using an extract of cotton spinning black liquor according to claim 7, wherein in step (2-1), the extract of cotton spinning black liquor is dried at a temperature of 80° C. for 48 h, and the undersize obtained after the extract of cotton spinning black liquor is pulverized and passed through a 60-mesh screen is the extract powder of cotton spinning black liquor;
in step (2-2), a mass ratio of the extract powder of cotton spinning black liquor to the formaldehyde to the distilled water is 5:2:2, and the refluxing is carried out at a temperature of 80° C. for 5 h; and
in step (2-3), the pH of the hydroxymethyl modification mixed system is adjusted to 2 with the hydrochloric acid with a concentration of 1 mol/L, and the undersize obtained after the precipitate is dried at a temperature of 80° C. for 48 h, pulverized and passed through a 60-mesh screen is the hydroxymethyl modified extract of cotton spinning black liquor.

9. The method for preparing a polyurethane foam using an extract of cotton spinning black liquor according to claims 1, wherein in step (2), a mass fraction of the pretreated extract of cotton spinning black liquor in the mixed raw material is 10-50 wt %.

10. The method for preparing a polyurethane foam using an extract of cotton spinning black liquor according to claim 9, wherein a method for preparing the polyurethane foam by one-step foaming comprises:
step (3-1): sequentially adding the dibutyltin dilaurate, the distilled water, the foam stabilizer and the aluminum hypophosphite to the mixed raw material, and uniformly stirring and mixing the mixture to obtain a polyurethane mixed foaming raw material, a mass ratio of the mixed raw material to the dibutyltin dilaurate to the distilled water to the foam stabilizer to the aluminum hypophosphite being (3-5):(0.03-0.05):(0.15-0.2):(0.15-0.2):(2.25-3.45);
step (3-2): adding the isocyanate to the polyurethane mixed foaming raw material with stirring, and uniformly stirring the mixture; after foaming, transferring the expanded material into a mold, and allowing the expanded material to continue foaming at 50° C. for 1 h; after the foaming is completed, cooling the foam product to room temperature, a mass ratio of the isocyanate to the dibutyltin dilaurate being (3.5-5.75):(0.03-0.05); and
step (3-3): curing the foam product that has been cooled to room temperature at room temperature for 48 h or in an 80° C. oven for 24 h to obtain the polyurethane foam.
